(19) United States
(12) Patent Application Publication
(10) Pub. No.: US 2026/0062856 A1
(43) Pub. Date: Mar. 5, 2026

(54) TIDYING ROBOT FOR FOLDING LAUNDRY

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/313,836

(22) Filed: Aug. 28, 2025

Related U.S. Application Data
(60) Provisional application No. 63/688,632, filed on Aug. 29, 2024.

(51) Int. Cl. D06F 89/02; B25J 5/00; B25J 9/16; B25J 11/00; B25J 15/00

(52) U.S. Cl. CPC D06F 89/026; B25J 5/007; B25J 9/1653; B25J 9/1697; B25J 11/008; B25J 15/0052

(57) ABSTRACT

A method for folding laundry is provided, where a robot approaches the clothes, identifying the type of clothing and key points for folding the clothing with a camera, and then uses a scoop and pusher pad assemblies to grab and manipulate the articles of clothing. The robot uses gripper arms and pinch grippers to grasp and move the clothing items, with the help of a camera that guides the folding process by guiding the manipulation devices to the key points on the clothing. The robot then moves the folded clothing items to a desired location using the scoop.

This application claims the benefit of U.S. provisional patent application Ser. No. 63/688,632, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

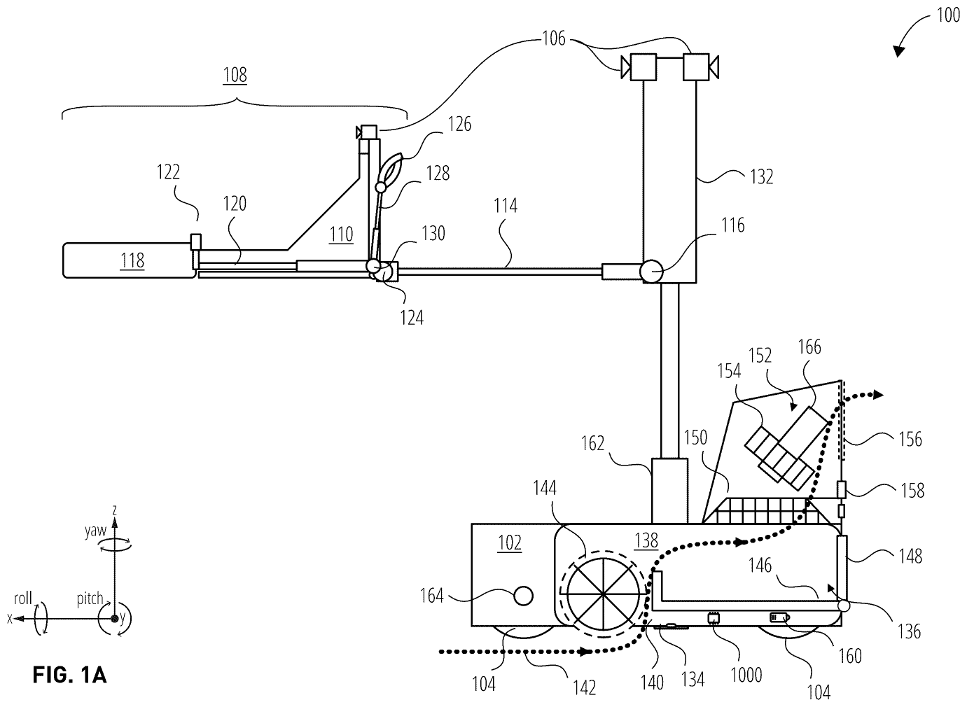

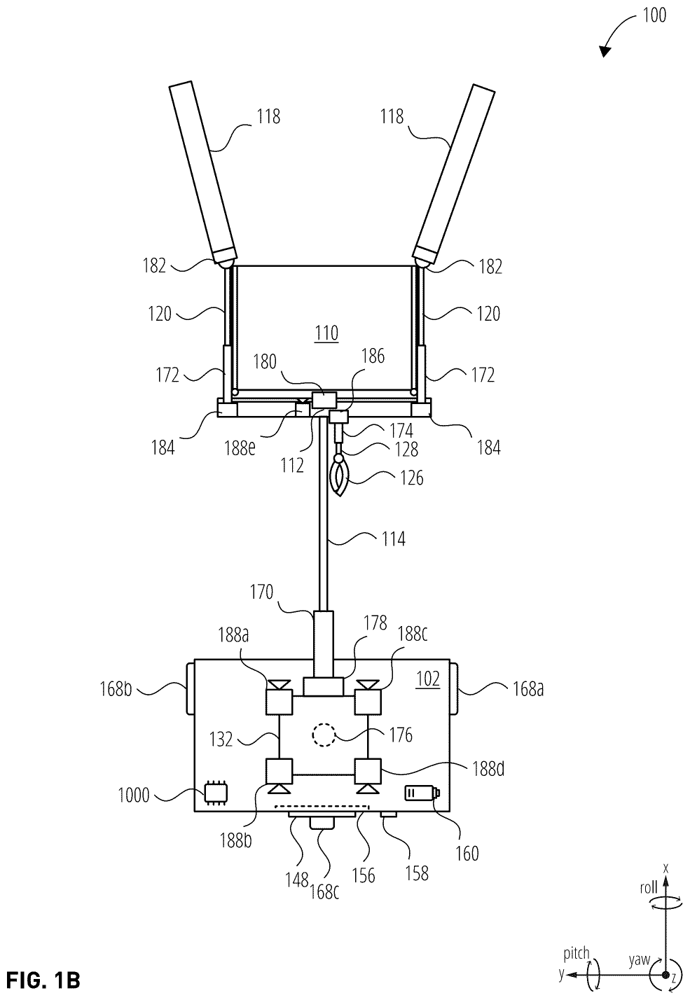

FIG. 1A and FIG. 1B illustrate a tidying robot 100 in accordance with one embodiment. FIG. 1A shows a side view and FIG. 1B shows a top view.

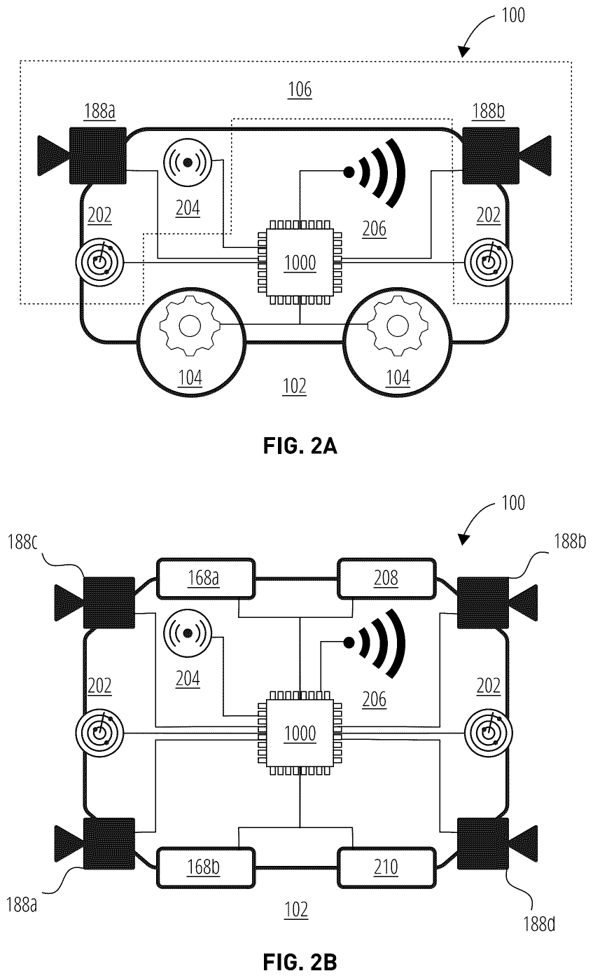

FIG. 2A and FIG. 2B illustrate a simplified side view and top view of a chassis 102 of the tidying robot 100, respectively.

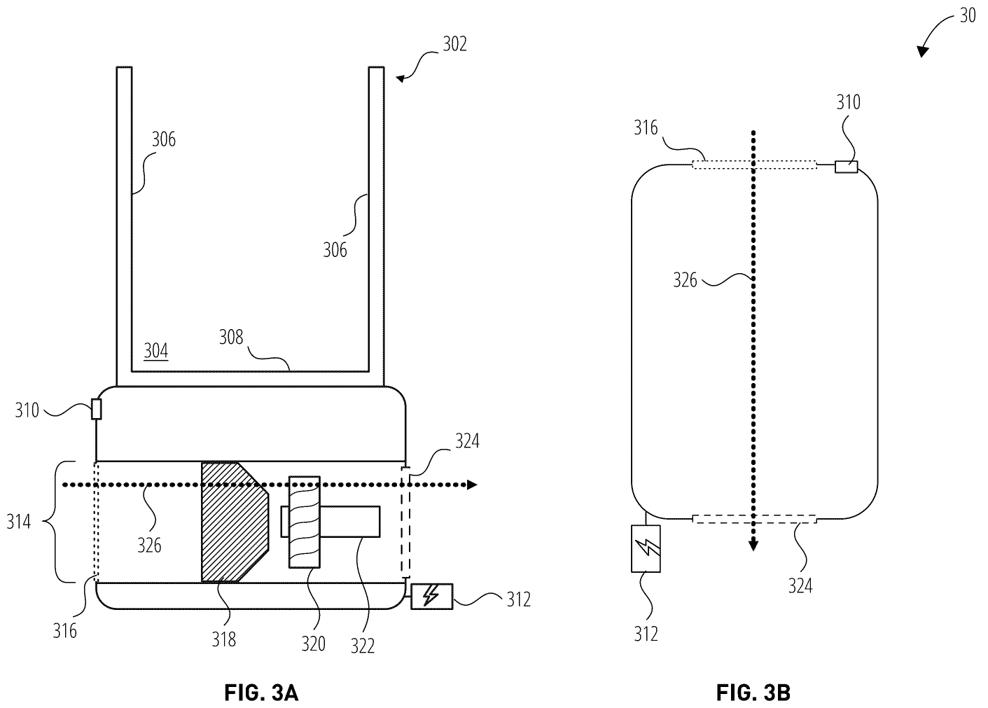

FIG. 3A and FIG. 3B illustrate a left side view and a top view of a base station 300, respectively, in accordance with one embodiment.

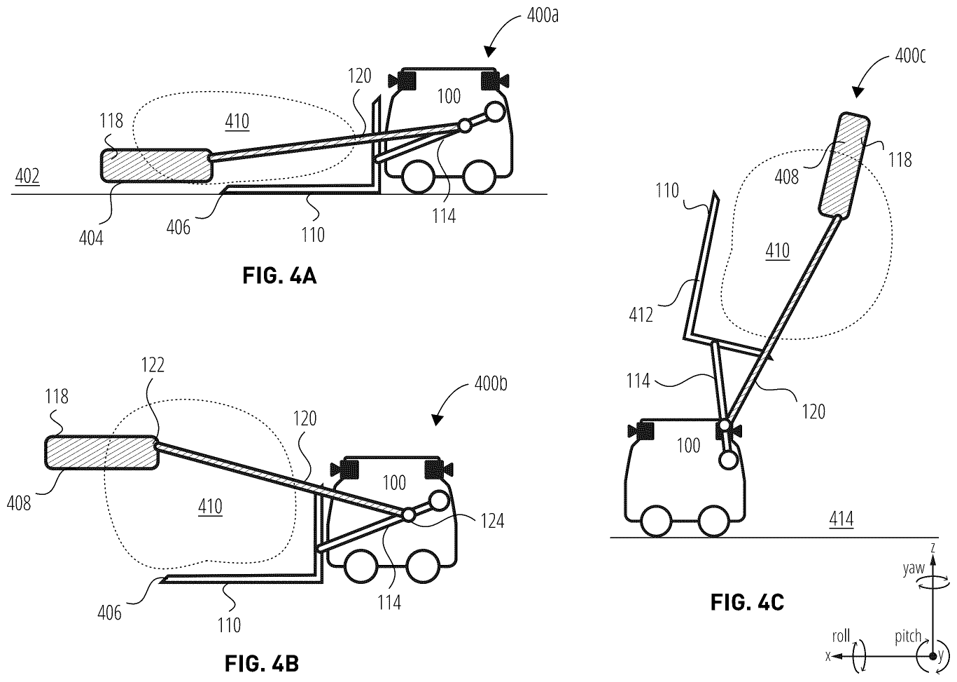

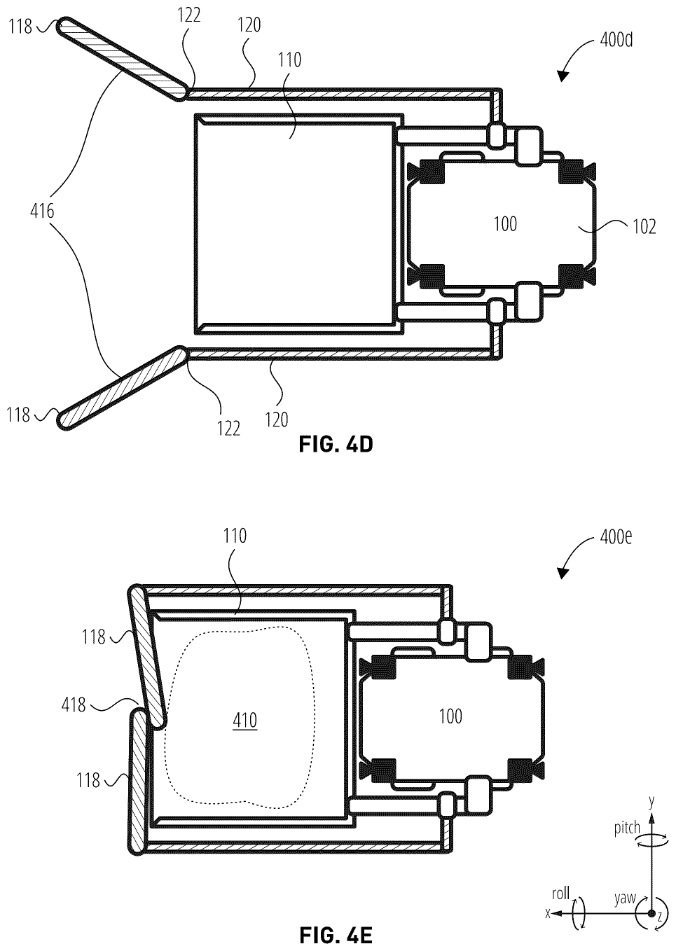

FIG. 4A illustrates a lowered scoop position and lowered pusher position 400a for the tidying robot 100 in accordance with one embodiment.

FIG. 4B illustrates a lowered scoop position and raised pusher position 400b for the tidying robot 100 in accordance with one embodiment.

FIG. 4C illustrates a raised scoop position and raised pusher position 400c for the tidying robot 100 in accordance with one embodiment.

FIG. 4D illustrates a tidying robot 100 with pusher pads extended 400d in accordance with one embodiment.

FIG. 4E illustrates a tidying robot 100 with pusher pads retracted 400e in accordance with one embodiment.

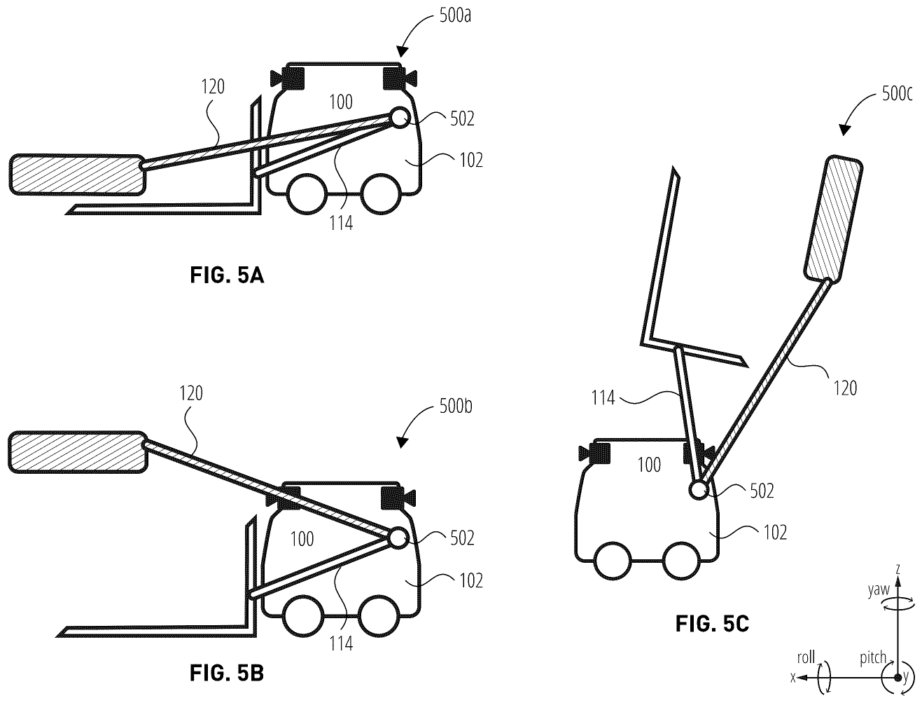

FIG. 5A illustrates a lowered scoop position and lowered pusher position 500a for the tidying robot 100 in accordance with one embodiment.

FIG. 5B illustrates a lowered scoop position and raised pusher position 500b for the tidying robot 100 in accordance with one embodiment.

FIG. 5C illustrates a raised scoop position and raised pusher position 500c for the tidying robot 100 in accordance with one embodiment.

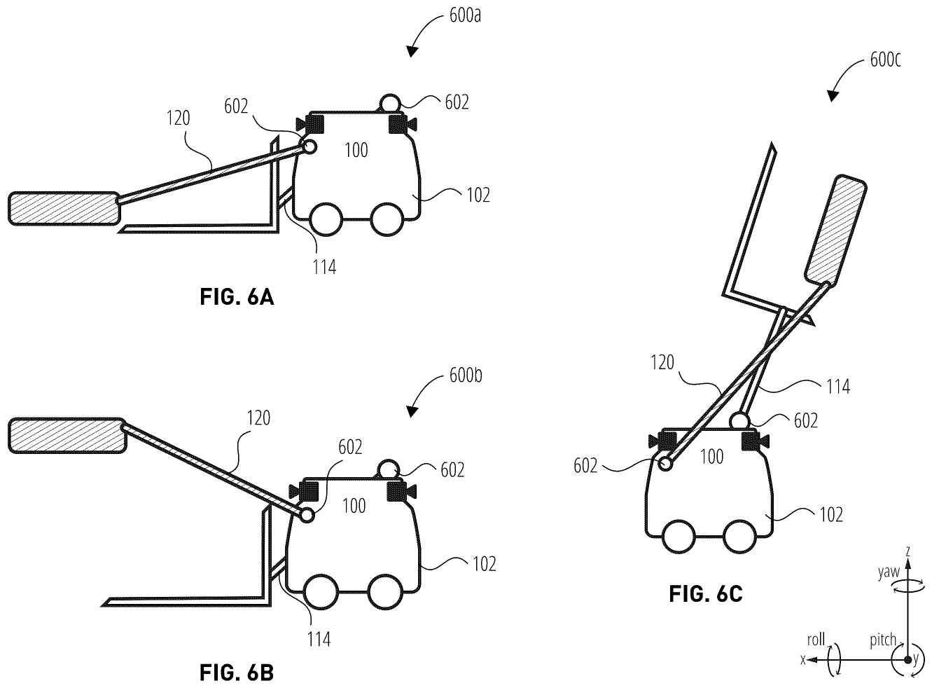

FIG. 6A illustrates a lowered scoop position and lowered pusher position 600a for the tidying robot 100 in accordance with one embodiment.

FIG. 6B illustrates a lowered scoop position and raised pusher position 600b for the tidying robot 100 in accordance with one embodiment.

FIG. 6C illustrates a raised scoop position and raised pusher position 600c for the tidying robot 100 in accordance with one embodiment.

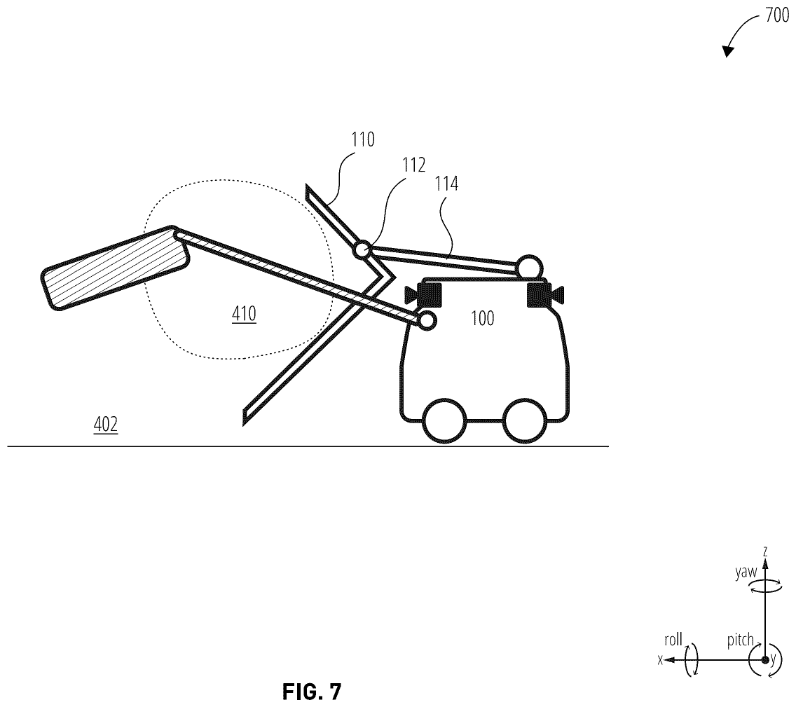

FIG. 7 illustrates a front dump action 800 for the tidying robot 100 in accordance with one embodiment.

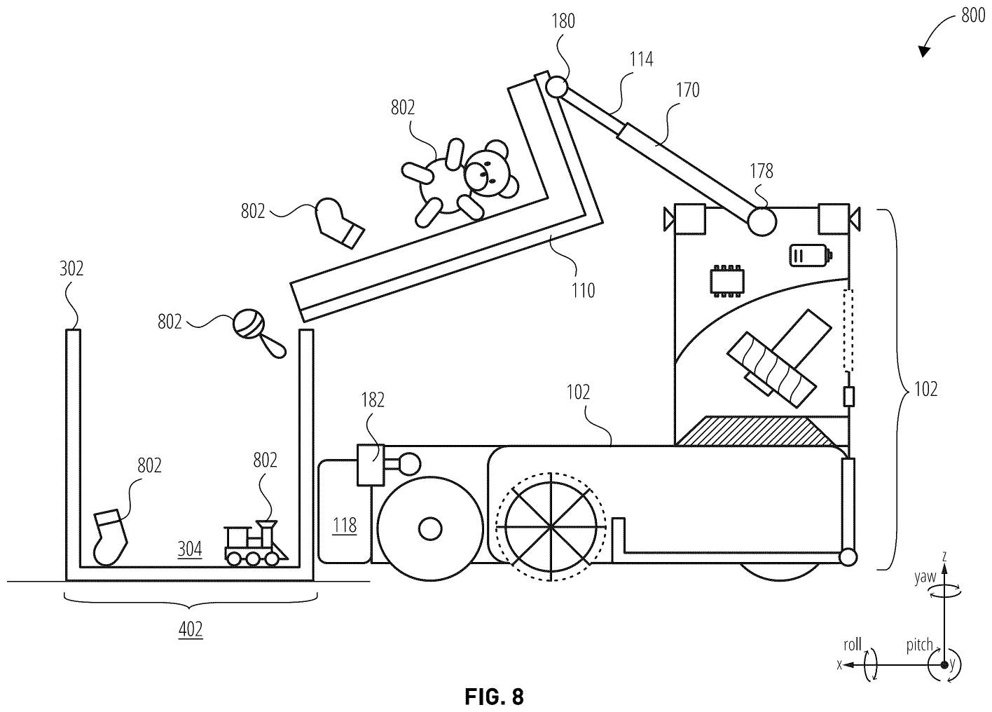

FIG. 8 illustrates a tidying robot 100 performing a front dump in accordance with one embodiment.

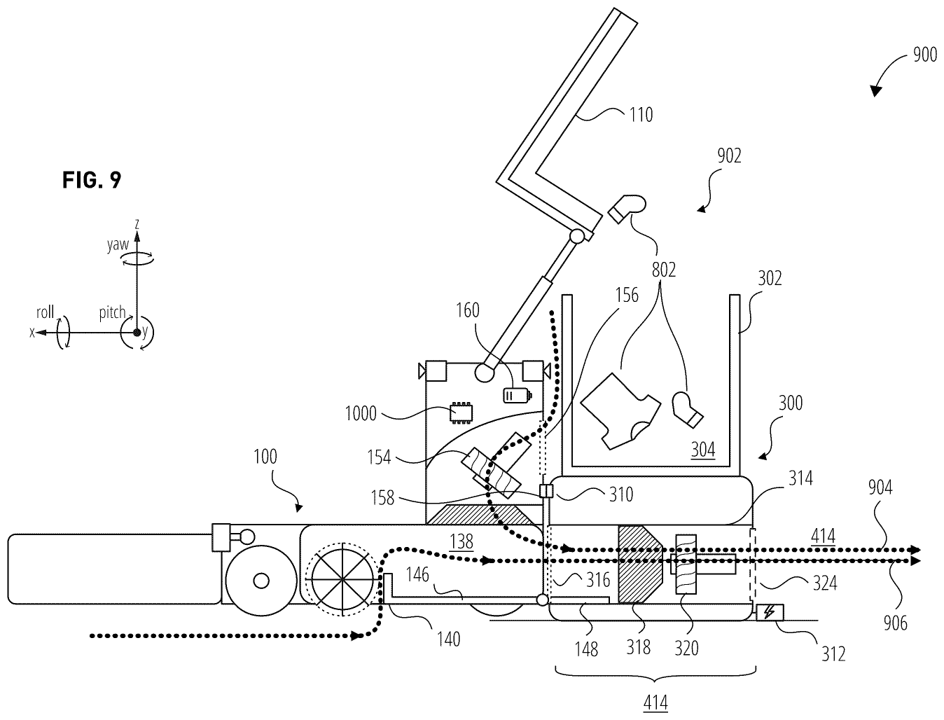

FIG. 9 illustrates a tidying robotic system interaction 900 in accordance with one embodiment.

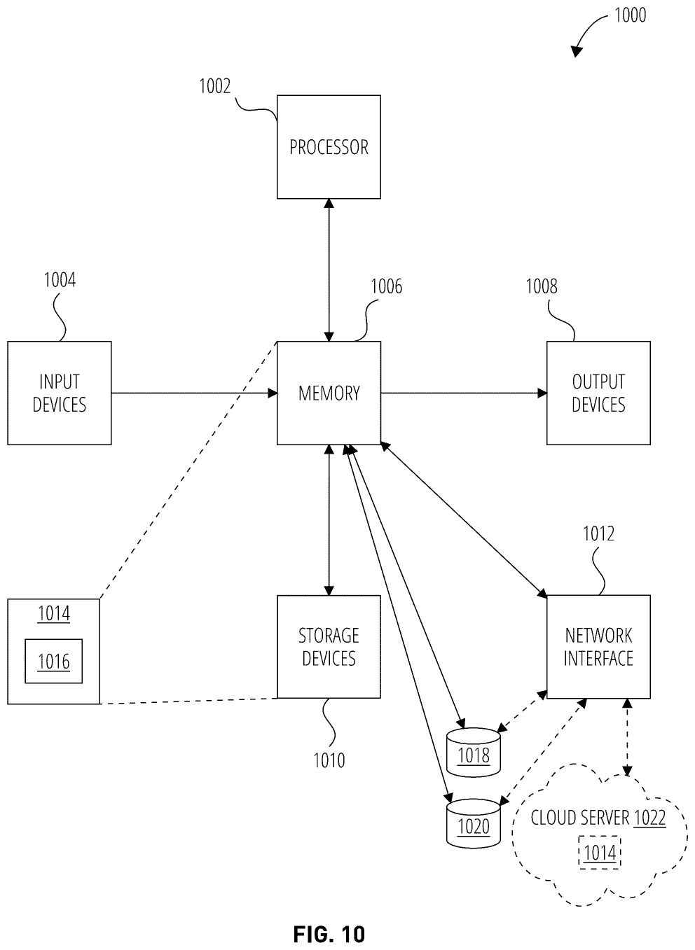

FIG. 10 illustrates an embodiment of a robotic control system 1000 to implement components and process steps of the system described herein.

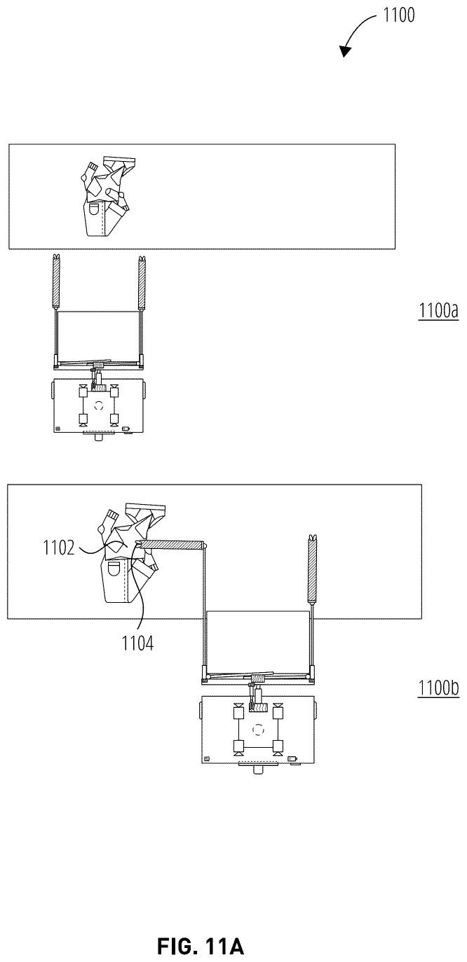

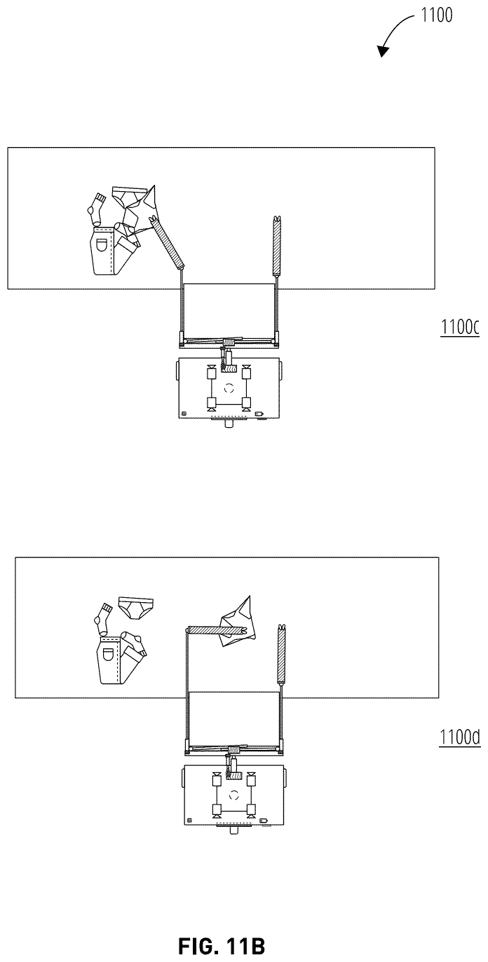

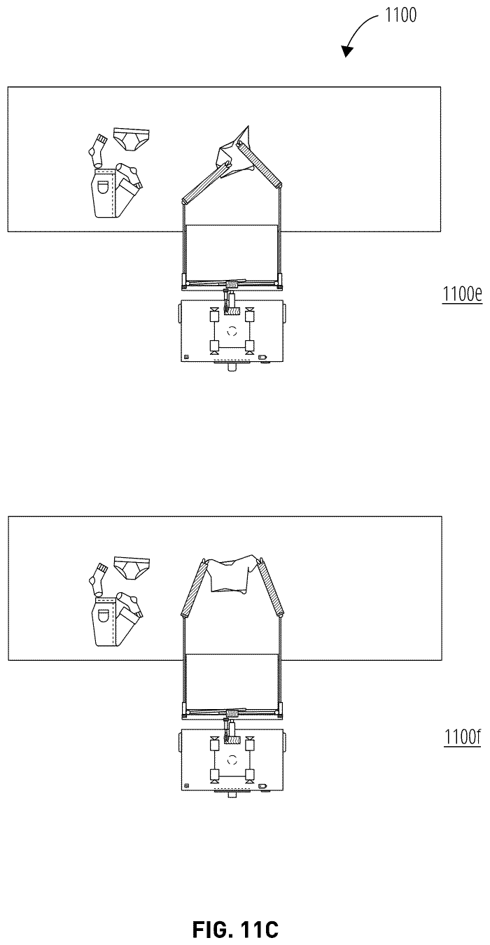

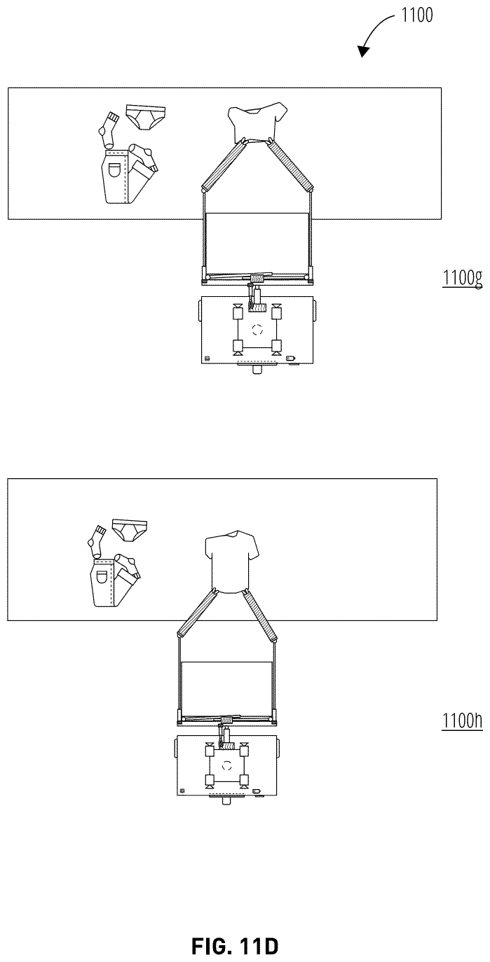

FIG. 11A-FIG. 11D illustrate a method 1100 in accordance with one embodiment.

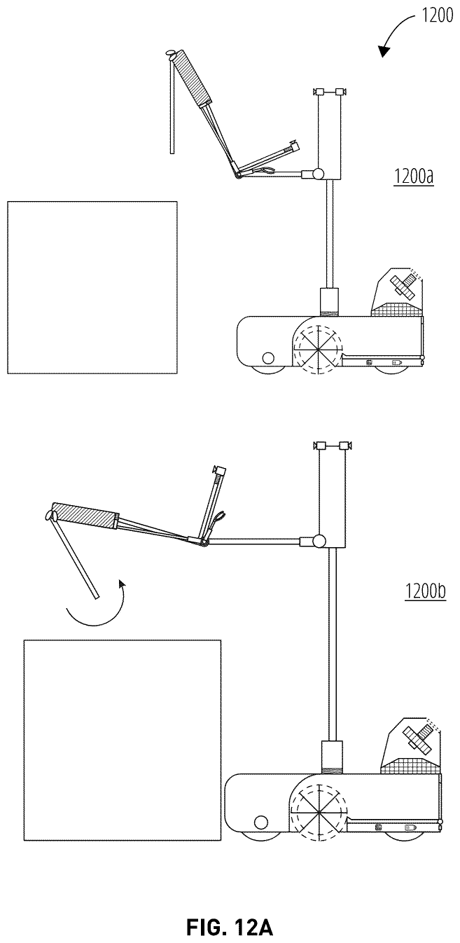

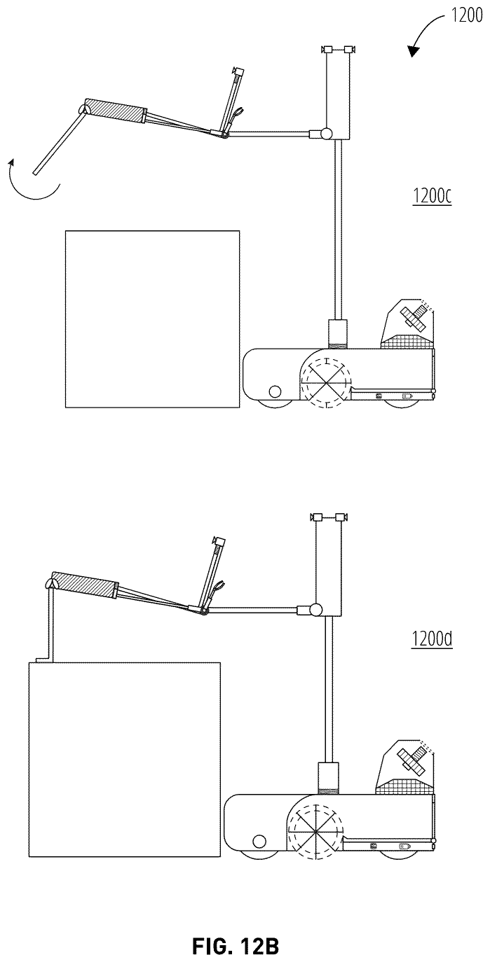

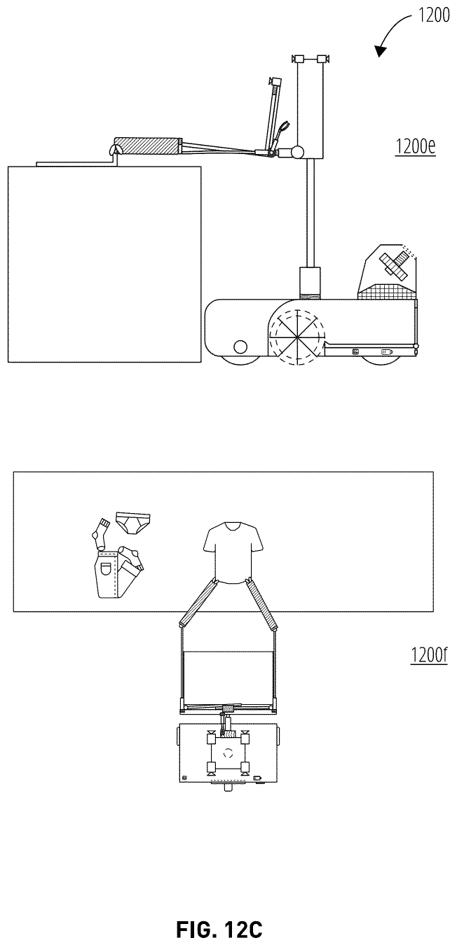

FIG. 12A-FIG. 12C illustrate a method 1200 in accordance with one embodiment.

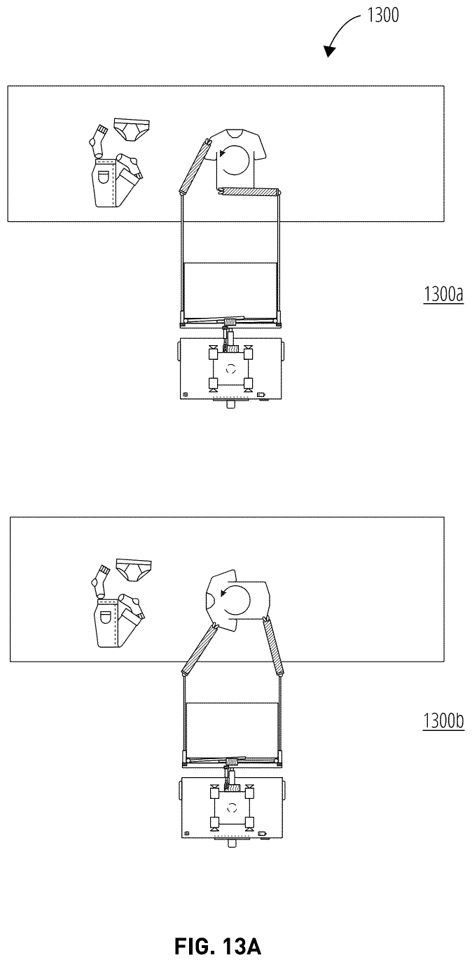

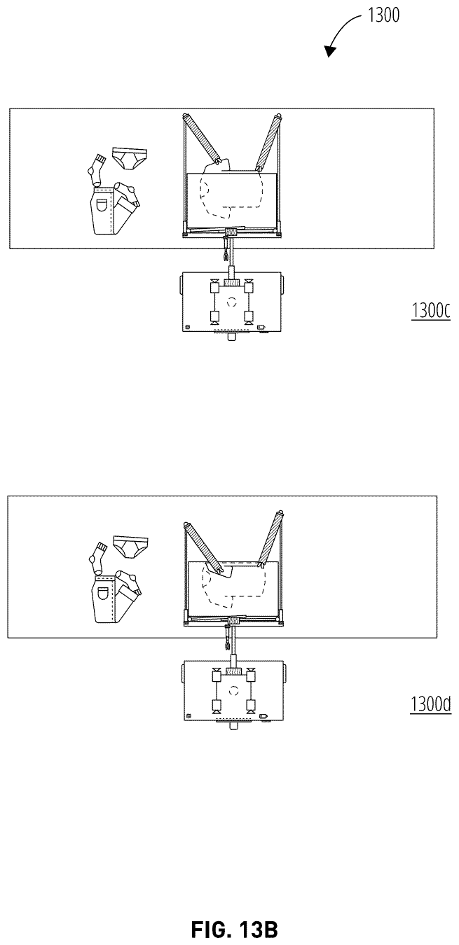

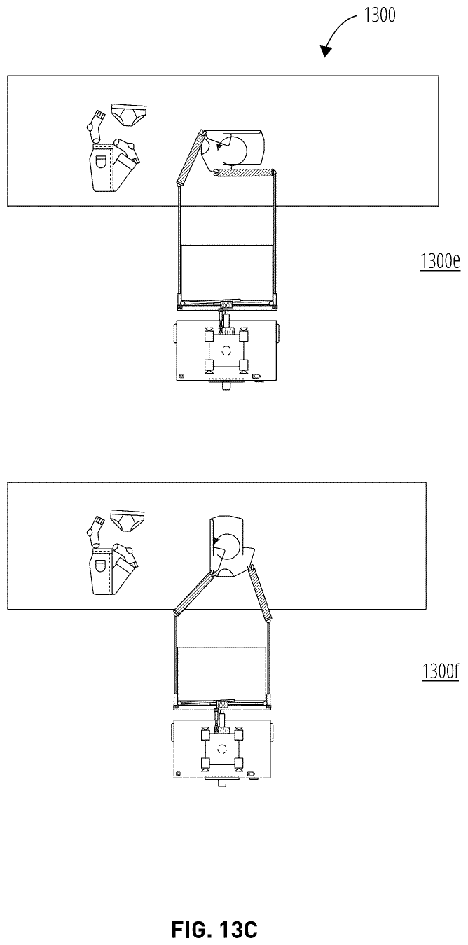

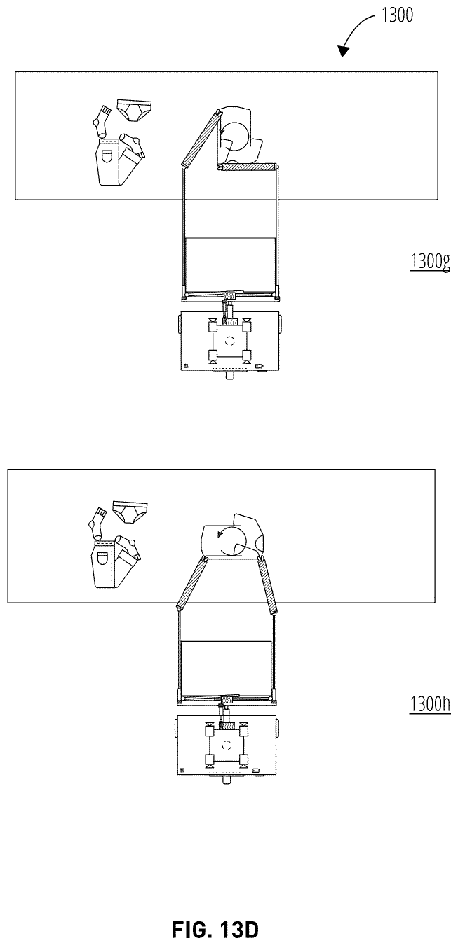

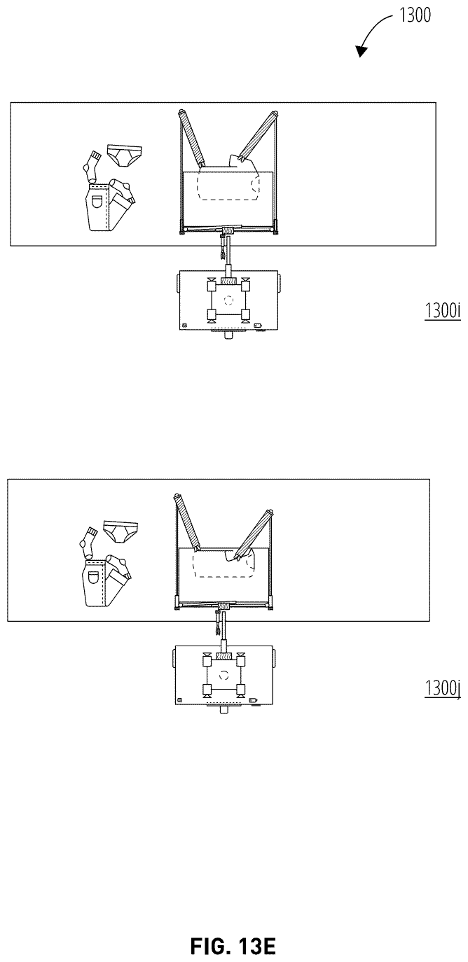

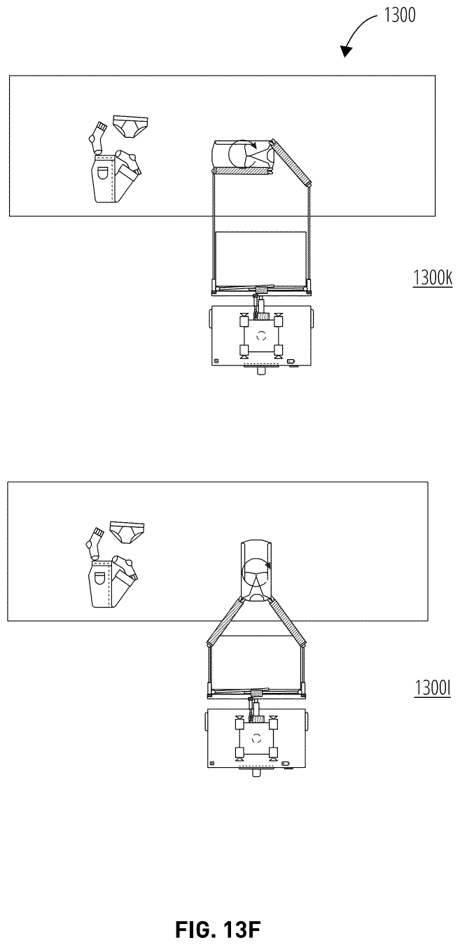

FIG. 13A-FIG. 13G illustrate a method 1300 in accordance with one embodiment.

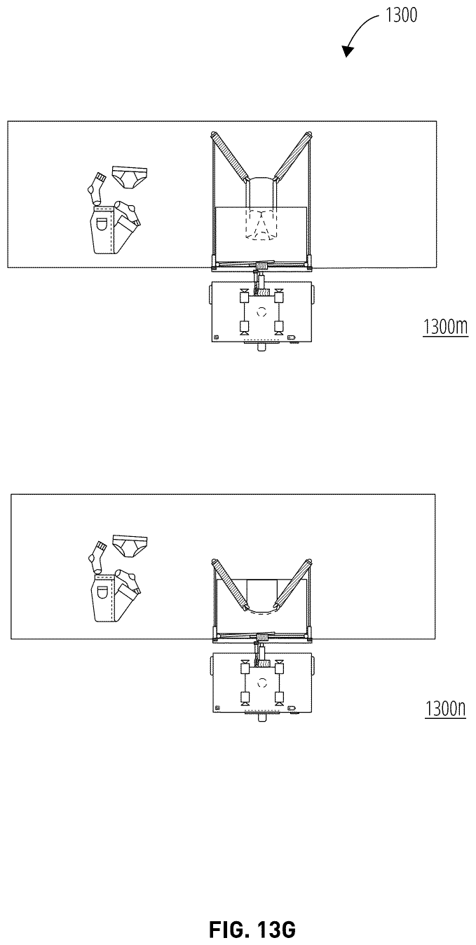

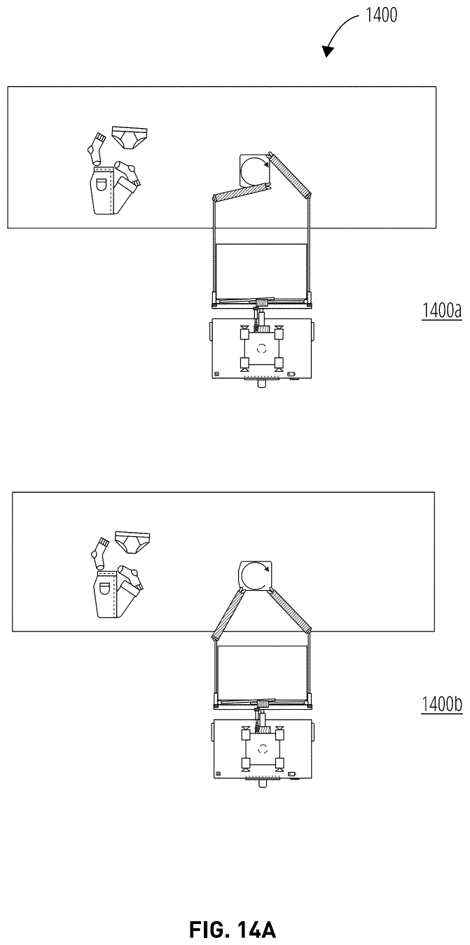

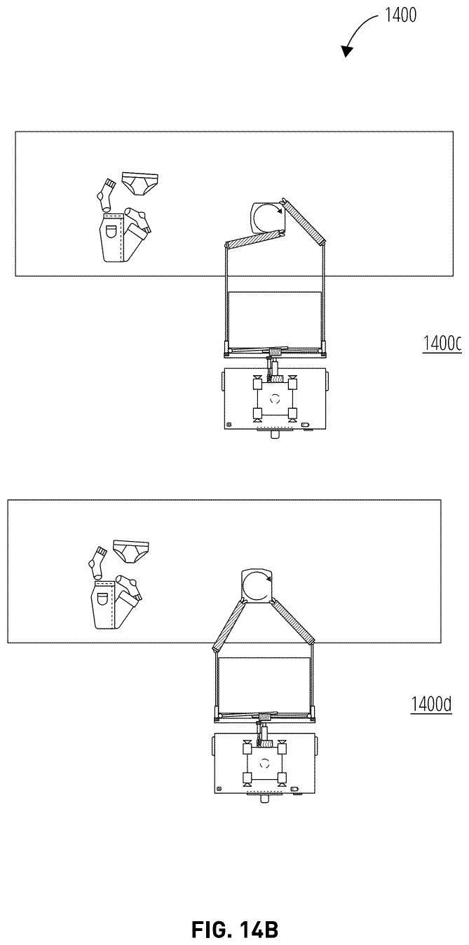

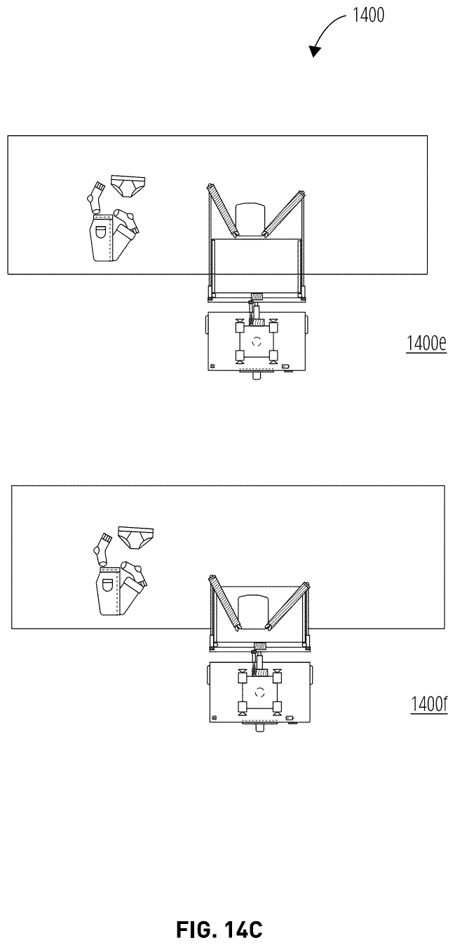

FIG. 14A-FIG. 14C illustrate a method 1400 in accordance with one embodiment.

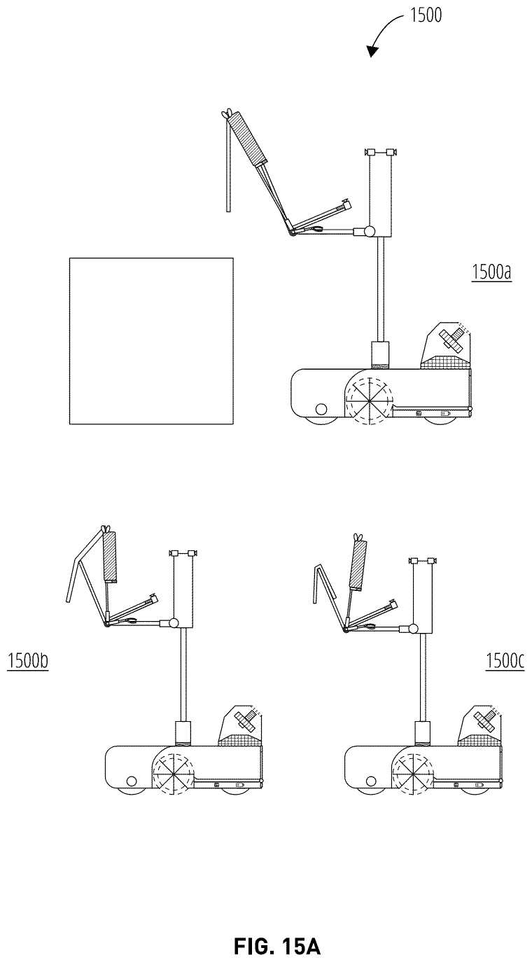

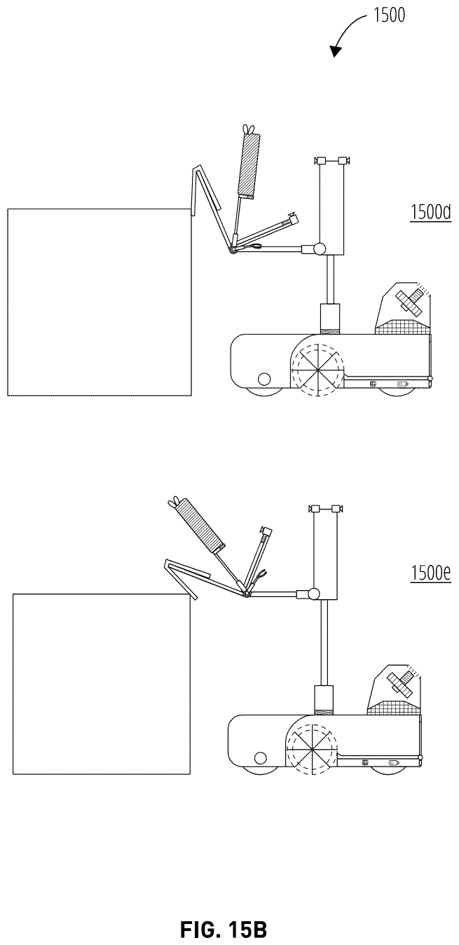

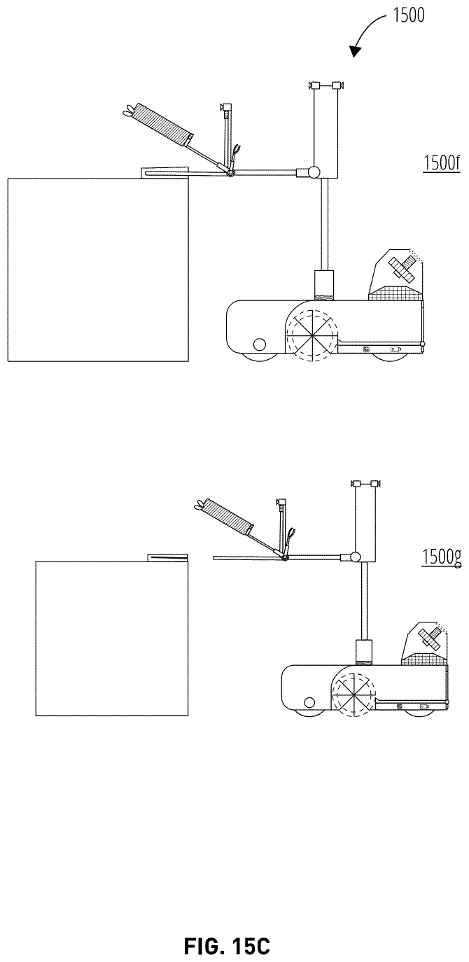

FIG. 15A-FIG. 15C illustrate a method 1500 in accordance with one embodiment.

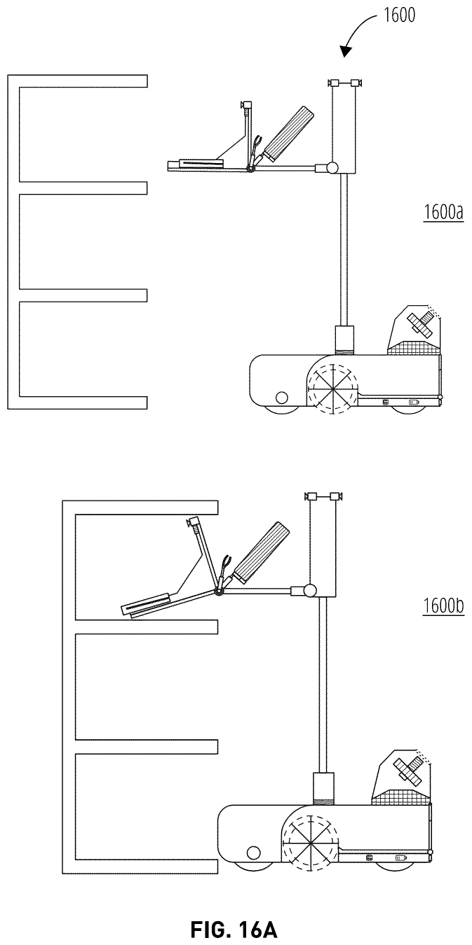

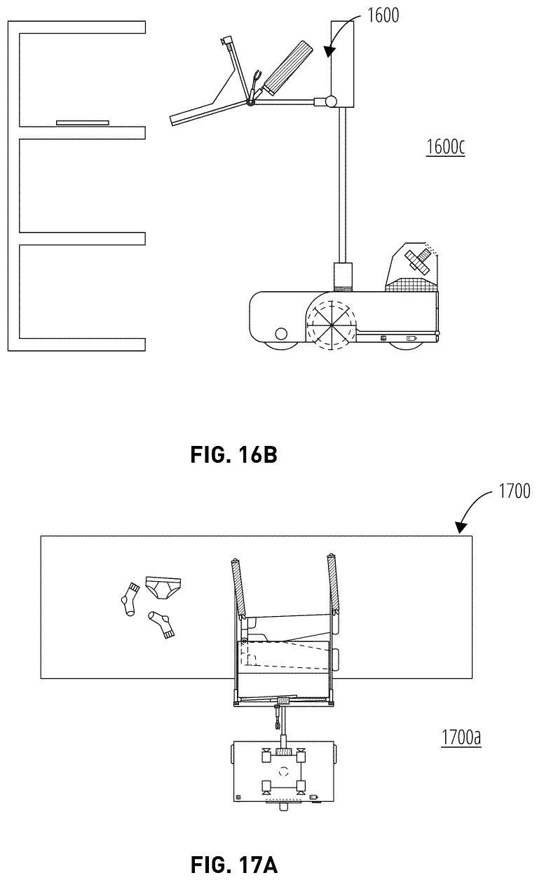

FIG. 16A-FIG. 16B illustrate a method 1600 in accordance with one embodiment.

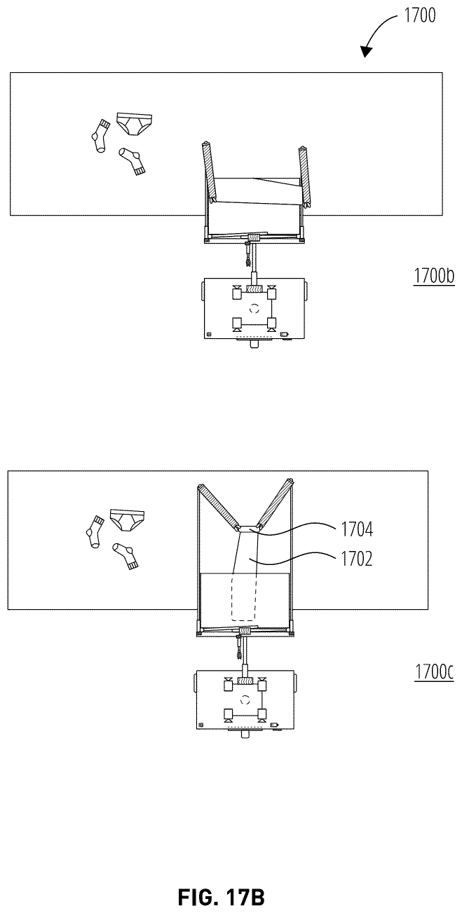

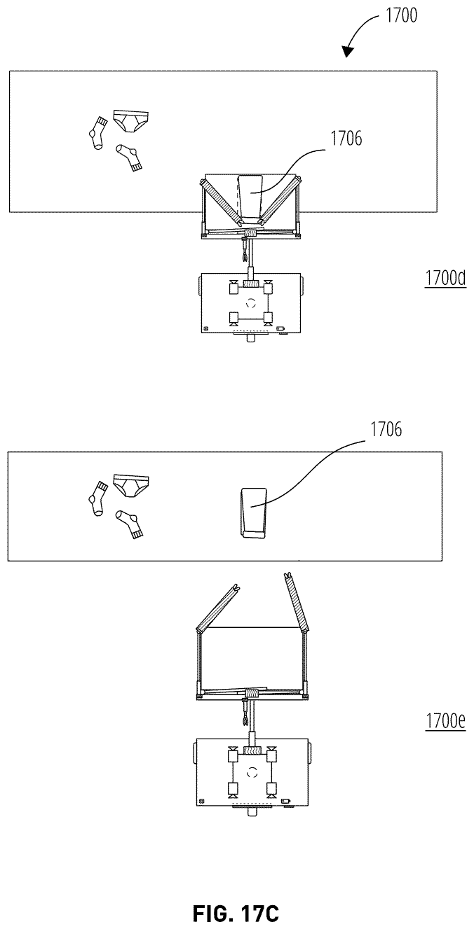

FIG. 17A-FIG. 17C illustrate a method 1700 in accordance with one embodiment.

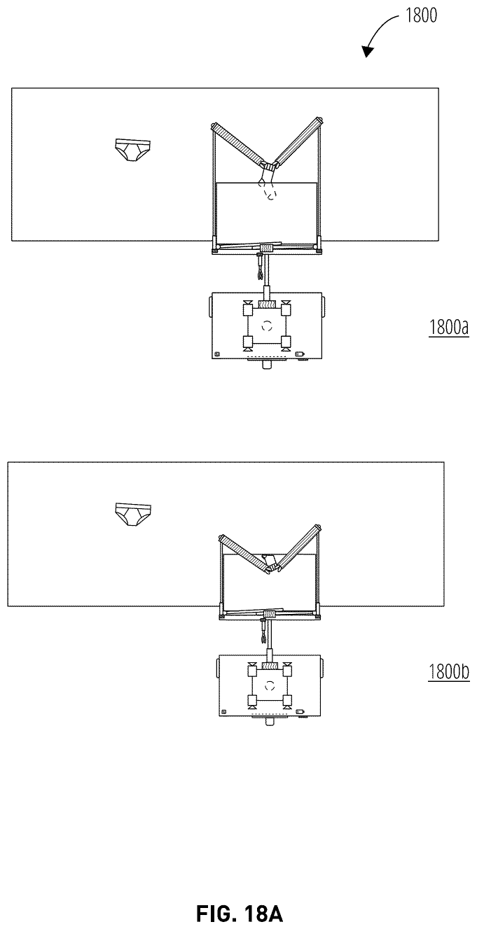

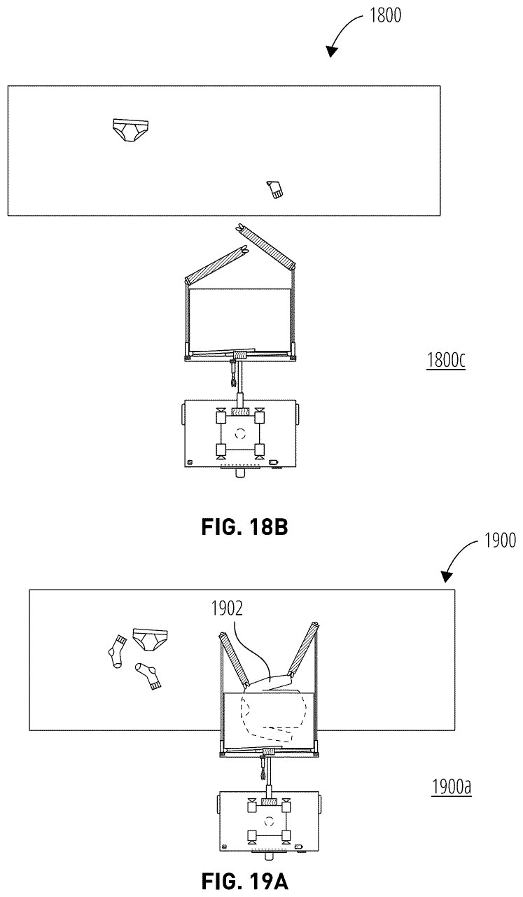

FIG. 18A-FIG. 18B illustrate a method 1800 in accordance with one embodiment.

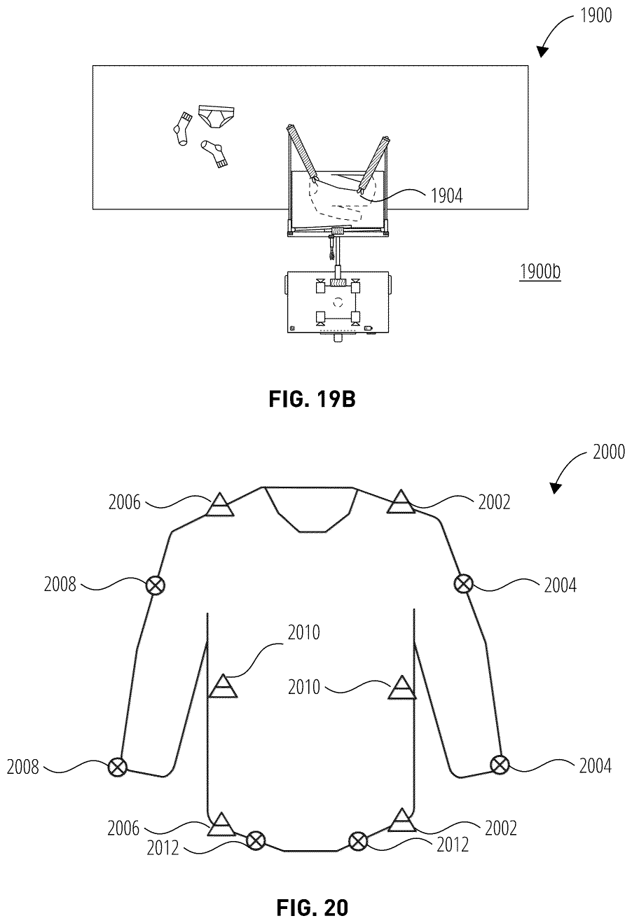

FIG. 19A-FIG. 19B illustrate a method 1900 in accordance with one embodiment.

FIG. 20 illustrates an aspect of the subject matter in accordance with one embodiment.

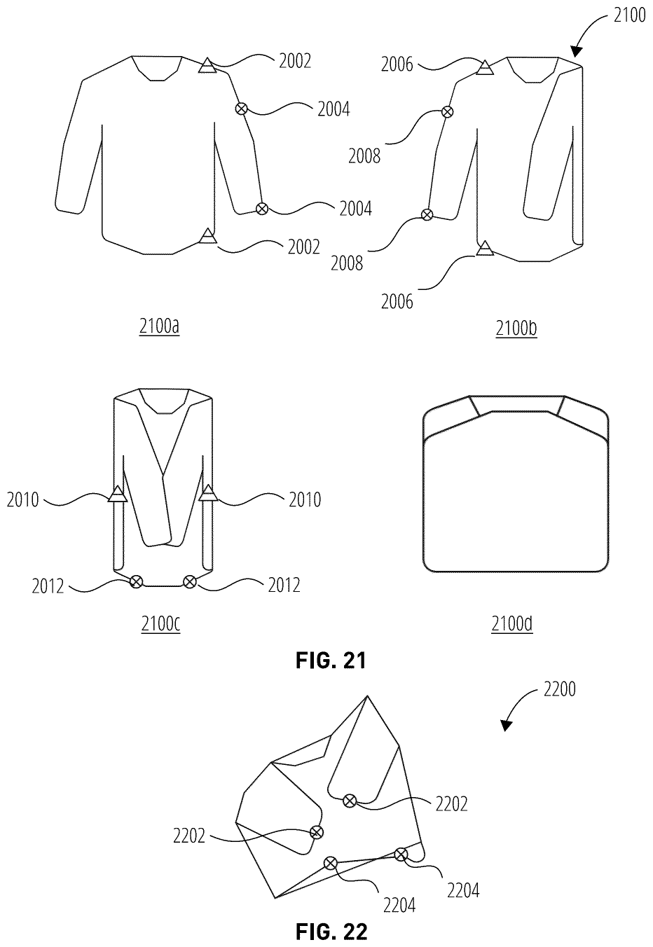

FIG. 21 illustrates a key point identification 2100 in accordance with one embodiment.

FIG. 22 illustrates a key point identification 2200 in accordance with one embodiment.

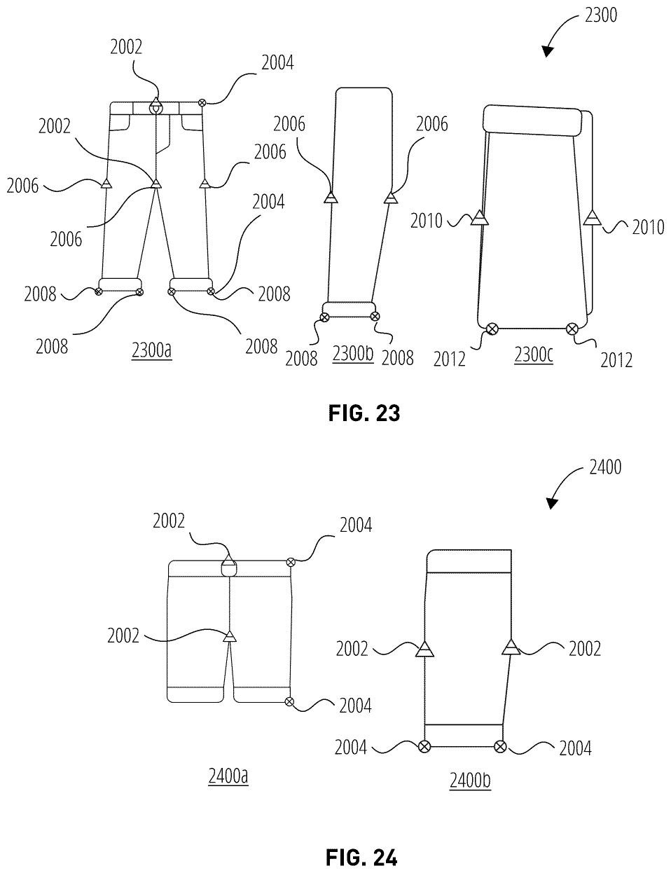

FIG. 23 illustrates a key point identification 2300 in accordance with one embodiment.

FIG. 24 illustrates a key point identification 2400 in accordance with one embodiment.

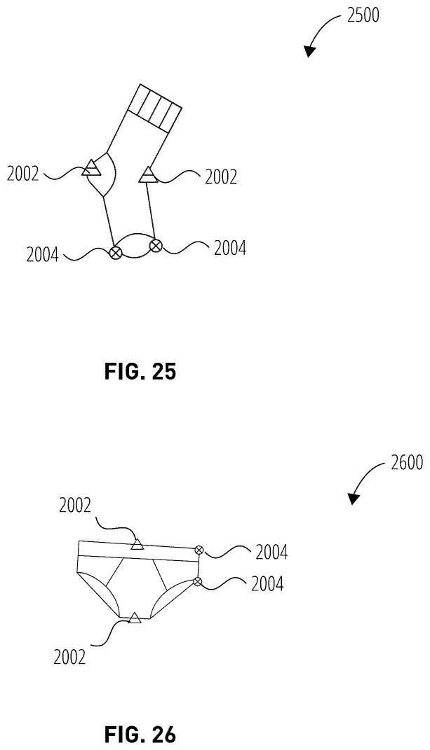

FIG. 25 illustrates a key point identification 2500 in accordance with one embodiment.

FIG. 26 illustrates a key point identification 2600 in accordance with one embodiment.

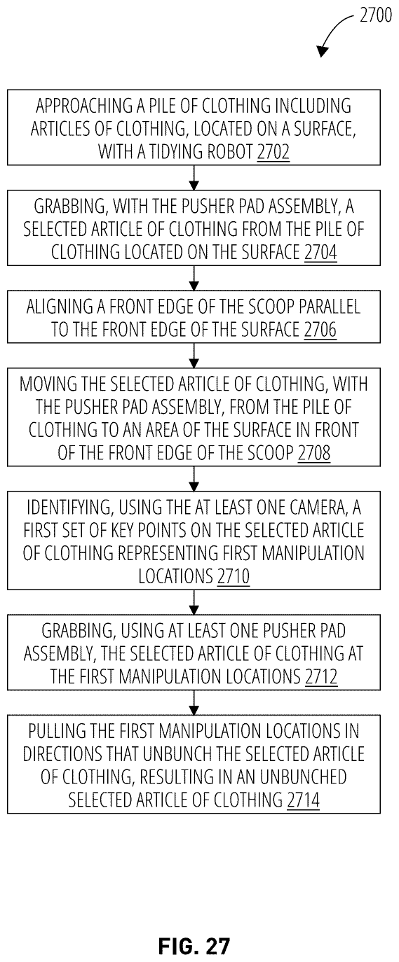

FIG. 27 illustrates a method 2700 in accordance with one embodiment.

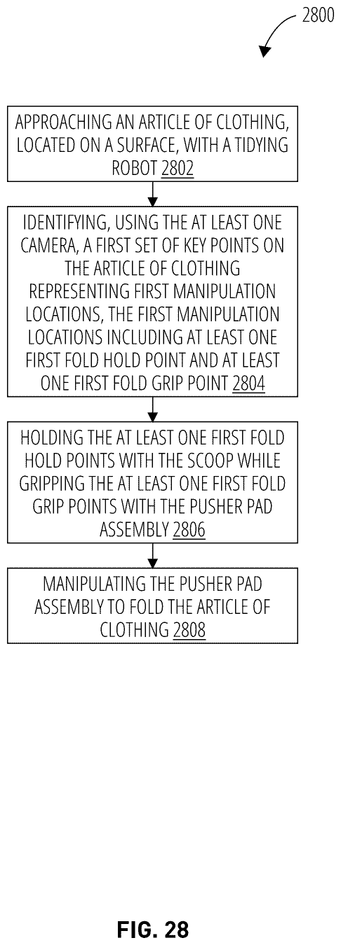

FIG. 28 illustrates a method 2800 in accordance with one embodiment.

### DETAILED DESCRIPTION

A General Purpose Tidying Robot may be configured with fabric grippers at the end of each pusher arm, such as a soft pinch-style gripper with a reasonably high friction with fabric. The tidying robot may thus be able to perform fabric manipulation tasks. Such a robot may be configured to maneuver these grippers in coordinated action so as to raise, spread, arrange, and fold laundry, including garments and bed, bath, and kitchen linens.

FIG. 1A-FIG. 2B illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 1000. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 134, and robot vacuum system 136. The robot vacuum system 136 may include a vacuum compartment 138, a vacuum compartment intake port 140, a cleaning airflow 142, a rotating brush 144, a dirt collector 146, a dirt release latch 148, a vacuum compartment filter 150, and a vacuum generating assembly 152 that includes a vacuum compartment fan 154, a vacuum compartment motor 166, and a vacuum compartment exhaust port 156. The tidying robot 100 may include a robot charge connector 158, a battery 160, and number of motors, actuators, sensors, and mobility components as described in greater detail below, and a robotic control system 1000 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

The chassis 102 may house and protect all or portions of the robotic control system 1000, (portions of which may also be accessed via connection to a cloud server) comprising in some embodiments a processor, memory, and connections to the mobility system 104, sensing system 106, and capture and containment system 108. The chassis 102 may contain other electronic components such as batteries 160, wireless communications 206 devices, etc., as is well understood in the art of robotics. The robotic control system 1000 may function as described in greater detail with respect to FIG. 10. The mobility system 104 and or the robotic control system 1000 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 180 to rotate the scoop 110 into different positions at the scoop pivot point 112. The capture and containment system 108 may also include a scoop arm 114 with an associated scoop arm motor 178 to rotate the scoop arm 114 into different positions around the scoop arm pivot point 116, and a scoop arm linear actuator 170 to extend the scoop arm 114. Pusher pads 118 of the capture and containment system 108 may have pusher pad motors 182 to rotate them into different positions around the pad pivot points 122. Pusher pad arms 120 may be associated with pusher pad arm motors 184 that rotate them around pad arm pivot points 124, as well as pusher pad arm linear actuators 172 to extend and retract the pusher pad arms 120. The gripper arm 128 may include a gripper arm motor 186 to move the gripper arm 128 around a gripper pivot point 130, as well as a gripper arm linear actuator 174 to extend and retract the gripper arm 128. In this manner the gripper arm 128 may be able to move and position itself and/or the actuated gripper 126 to perform the tasks disclosed herein.

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 5A or FIG. 8. It will be well understood by one of ordinary skill in the art that the configurations illustrated may be designed to perform the basic motions described with respect to FIG. 4A-FIG. 9 and the processes illustrated elsewhere herein.

The geometry of the scoop 110 and the disposition of the pusher pads 118 and pusher pad arms 120 with respect to the scoop 110 may describe a containment area, illustrated more clearly in FIG. 4A-FIG. 4E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and grabber positions and raised scoop and grabber positions, as illustrated with respect to FIG. 4A-FIG. 4C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 162 may control the elevation of the capture and containment system 108 by extending and retracting the lifting column 132. A lifting column motor 176 may allow the lifting column 132 to rotate so that the capture and containment system 108 may be moved with respect to the tidying robot 100 base or chassis 102 in all three dimensions.

The tidying robot 100 may include floor cleaning components such as a mop pad 134 and a vacuuming system. The mop pad 134 may be able to raise and lower with respect to the bottom of the tidying robot 100 chassis 102, so that it may be placed in contact with the floor when desired. The mop pad 134 may include a drying element to dry wet spots detected on the floor. In one embodiment, the tidying robot 100 may include a fluid reservoir, which may be in contact with the mop pad 134 and able to dampen the mop pad 134 for cleaning. In one embodiment, the tidying robot 100 may be able to spray cleaning fluid from a fluid reservoir onto the floor in front of or behind the tidying robot 100, which may then be absorbed by the mop pad 134.

The vacuuming system may include a vacuum compartment 138, which may have a vacuum compartment intake port 140 allowing cleaning airflow 142 into the vacuum compartment 138. The vacuum compartment intake port 140 may be configured with a rotating brush 144 to impel dirt and dust into the vacuum compartment 138. Cleaning airflow 142 may be induced to flow by a vacuum compartment fan 154 powered by a vacuum compartment motor 166. cleaning airflow 142 may pass through the vacuum compartment 138 from the vacuum compartment intake port 140 to a vacuum compartment exhaust port 156, exiting the vacuum compartment 138 at the vacuum compartment exhaust port 156. The vacuum compartment exhaust port 156 may be covered by a grating or other element permeable to cleaning airflow 142 but able to prevent the ingress of objects into the chassis 102 of the tidying robot 100.

A vacuum compartment filter 150 may be disposed between the vacuum compartment intake port 140 and the vacuum compartment exhaust port 156. The vacuum compartment filter 150 may prevent dirt and dust from entering and clogging the vacuum compartment fan 154. The vacuum compartment filter 150 may be disposed such that blocked dirt and dust are deposited within a dirt collector 146. The dirt collector 146 may be closed off from the outside of the chassis 102 by a dirt release latch 148. The dirt release latch 148 may be configured to open when the tidying robot 100 is docked at a base station 300 with a vacuum emptying system 314, as is illustrated in FIG. 3A and FIG. 3B and described below. A robot charge connector 158 may connect the tidying robot 100 to a base station charge connector 310, allowing power from the base station 300 to charge the tidying robot 100 battery 160.

FIG. 2A and FIG. 2B illustrate a simplified side view and top view of a chassis 102, respectively, in order to show in more detail aspects of the mobility system 104, the sensing system 106, and the communications 206, in connection with the robotic control system 1000. In some embodiments, the communications 206 may include the network interface 1012 described in greater detail with respect to robotic control system 1000.

In one embodiment, the mobility system 104 may comprise a left front wheel 168b and a right front wheel 168a powered by mobility system motor 164, and a single rear wheel 168c, as illustrated in FIG. 1A and FIG. 1B. The single rear wheel 168c may be actuated or may be a passive roller or caster providing support and reduced friction with no driving force.

In one embodiment, the mobility system 104 may comprise a right front wheel 168a, a left front wheel 168b, a right rear wheel 208, and a left rear wheel 210. The tidying robot 100 may have front-wheel drive, where right front wheel 168a and left front wheel 168b are actively driven by one or more actuators or motors, while the right rear wheel 208 and left rear wheel 210 spin on an axle passively while supporting the rear portion of the chassis 102. In another embodiment, the tidying robot 100 may have rear-wheel drive, where the right rear wheel 208 and left rear wheel 210 are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras such as the front left camera 188a, rear left camera 188b, front right camera 188c, rear right camera 188d, and scoop camera 188e, light detecting and ranging (LIDAR) sensors such as lidar sensors 202, and inertial measurement unit (IMU) sensors, such as IMU sensors 204. In some embodiments, there may be a single front camera and a single rear camera.

FIG. 3A and FIG. 3B illustrate a base station 300 in accordance with one embodiment. FIG. 3A shows a left side view and FIG. 3B shows a top view. The base station 300 may comprise an object collection bin 302 with a storage compartment 304 to hold tidyable objects, heavy dirt and debris, or other obstructions. The storage compartment 304 may be formed by bin sides 306 and a bin base 308. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 300 may further comprise a base station charge connector 310, a power source connection 312, and a vacuum emptying system 314 including a vacuum emptying system intake port 316, a vacuum emptying system filter bag 318, a vacuum emptying system fan 320, a vacuum emptying system motor 322, and a vacuum emptying system exhaust port 324.

The object collection bin 302 may be configured on top of the base station 300 so that a tidying robot 100 may deposit objects from the scoop 110 into the object collection bin 302. The base station charge connector 310 may be electrically coupled to the power source connection 312. The power source connection 312 may be a cable connector configured to couple through a cable to an alternating current (AC) or direct current (DC) source, a battery, or a wireless charging port, as will be readily apprehended by one of ordinary skill in the art. In one embodiment, the power source connection 312 is a cable and male connector configured to couple with 120V AC power, such as may be provided by a conventional U.S. home power outlet.

The vacuum emptying system 314 may include a vacuum emptying system intake port 316 allowing vacuum emptying airflow 326 into the vacuum emptying system 314. The vacuum emptying system intake port 316 may be configured with a flap or other component to protect the interior of the vacuum emptying system 314 when a tidying robot 100 is not docked. A vacuum emptying system filter bag 318 may be disposed between the vacuum emptying system intake port 316 and a vacuum emptying system fan 320 to catch dust and dirt carried by the vacuum emptying airflow 326 into the vacuum emptying system 314. The vacuum emptying system fan 320 may be powered by a vacuum emptying system motor 322. The vacuum emptying system fan 320 may pull the vacuum emptying airflow 326 from the vacuum emptying system intake port 316 to the vacuum emptying system exhaust port 324, which may be configured to allow the vacuum emptying airflow 326 to exit the vacuum emptying system 314. The vacuum emptying system exhaust port 324 may be covered with a grid to protect the interior of the vacuum emptying system 314.

FIG. 4A illustrates a tidying robot 100 such as that introduced with respect to FIG. 1A disposed in a lowered scoop position and lowered pusher position 400a. In this configuration, the pusher pads 118 and pusher pad arms 120 rest in a lowered pusher position 404, and the scoop 110 and scoop arm 114 rest in a lowered scoop position 406 at the front 402 of the tidying robot 100. In this position, the scoop 110 and pusher pads 118 may roughly describe a containment area 410 as shown.

FIG. 4B illustrates a tidying robot 100 with a lowered scoop position and raised pusher position 400b. Through the action of servos or other actuators at the pad pivot points 122 and pad arm pivot points 124, the pusher pads 118 and pusher pad arms 120 may be raised to a raised pusher position 408 while the scoop 110 and scoop arm 114 maintain a lowered scoop position 406. In this configuration, the pusher pads 118 and scoop 110 may roughly describe a containment area 410 as shown, in which an object taller than the scoop 110 height may rest within the scoop 110 and be held in place through pressure exerted by the pusher pads 118.

Pad arm pivot points 124, pad pivot points 122, scoop arm pivot points 116 and scoop pivot points 112 (as shown in FIG. 7) may provide the tidying robot 100 a range of motion of these components beyond what is illustrated herein. The positions shown in the disclosed figures are illustrative and not meant to indicate the limits of the robot's component range of motion.

FIG. 4C illustrates a tidying robot 100 with a raised scoop position and raised pusher position 400c. The pusher pads 118 and pusher pad arms 120 may be in a raised pusher position 408 while the scoop 110 and scoop arm 114 are in a raised scoop position 412. In this position, the tidying robot 100 may be able to allow objects drop from the scoop 110 and pusher pad arms 120 to an area at the rear 414 of the tidying robot 100.

The carrying position may involve the disposition of the pusher pads 118, pusher pad arms 120, scoop 110, and scoop arm 114, in relative configurations between the extremes of lowered scoop position and lowered pusher position 400a and raised scoop position and raised pusher position 400c.

FIG. 4D illustrates a tidying robot 100 with pusher pads extended 400d. By the action of servos or other actuators at the pad pivot points 122, the pusher pads 118 may be configured as extended pusher pads 416 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 4E illustrates a tidying robot 100 with pusher pads retracted 400e. The closed pusher pads 418 may roughly define a containment area 410 through their position with respect to the scoop 110. In some embodiments, the pusher pads 118 may be able to rotate farther than shown, through almost three hundred and sixty degrees, to rest parallel with and inside of the side walls of the scoop 110.

FIG. 5A-FIG. 5C illustrate a tidying robot 100 such as that introduced with respect to FIG. 1A. In such an embodiment, the pusher pad arms 120 may be controlled by a servo or other actuator at the same point of connection 502 with the chassis 102 as the scoop arms 114. The tidying robot 100 may be seen disposed in a lowered scoop position and lowered pusher position 500a, a lowered scoop position and raised pusher position 500b, and a raised scoop position and raised pusher position 500c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

FIG. 6A-FIG. 6C illustrate a tidying robot 100 such as that introduced with respect to FIG. 1A. In such an embodiment, the pusher pad arms 120 may be controlled by a servo or servos (or other actuators) at different points of connection 602 with the chassis 102 from those controlling the scoop arm 114. The tidying robot 100 may be seen disposed in a lowered scoop position and lowered pusher position 600a, a lowered scoop position and raised pusher position 600b, and a raised scoop position and raised pusher position 600c. This tidying robot 100 may be configured to perform the algorithms disclosed herein.

The different points of connection 602 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 7 illustrates a tidying robot 100 such as was previously introduced in a front drop position 700. The arms of the tidying robot 100 may be positioned to form a containment area 410 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 410 to slide out and be deposited in an area to the front 402 of the tidying robot 100.

FIG. 8 illustrates how the positions of the components of the tidying robot 100 may be configured such that the tidying robot 100 may approach an object collection bin 302 and perform a front dump action 800. The scoop 110 may be raised by scoop arm motor 178, extended by scoop arm linear actuator 170, and tilted by scoop motor 180 so that tidyable objects 802 carried in the scoop 110 may be deposited into the storage compartment 304 of the object collection bin 302 positioned to the front 402 of the tidying robot 100, as is also described with respect to the front drop position 700 of FIG. 7.

FIG. 9 illustrates a tidying robotic system interaction 900 in accordance with one embodiment. The tidying robotic system may include the tidying robot 100, the base station 300, a robotic control system 1000, and logic 1014 that when executed directs the robot to perform the disclosed method. When the tidying robot 100 is docked at a base station 300 having an object collection bin 302, the scoop 110 may be raised and rotated up and over the tidying robot 100 chassis 102, allowing tidyable objects 802 in the scoop 110 to drop into the storage compartment 304 of the object collection bin 302 to the rear 414 of the tidying robot 100 in a rear dump action 902, as is also described with respect to the raised scoop position and raised pusher position 400c and raised scoop position and raised pusher position 500c described with respect to FIG. 4C and FIG. 5C, respectively.

In a docked state, the robot charge connector 158 may electrically couple with the base station charge connector 310 such that electrical power from the power source connection 312 may be carried to the battery 160, and the battery 160 may be recharged toward its maximum capacity for future use.

When the tidying robot 100 docks at its base station 300, the dirt release latch 148 may lower, allowing the vacuum compartment 138 to interface with the vacuum emptying system 314. Where the vacuum emptying system intake port 316 is covered by a protective element, the dirt release latch 148 may interface with that element to open the vacuum emptying system intake port 316 when the tidying robot 100 is docked. The vacuum compartment fan 154 may remain inactive or may reverse direction, permitting or compelling airflow 904 through the vacuum compartment exhaust port 156, into the vacuum compartment 138, across the dirt collector 146, over the dirt release latch 148, into the vacuum emptying system intake port 316, through the vacuum emptying system filter bag 318, and out the vacuum emptying system exhaust port 324, in conjunction with the operation of the vacuum emptying system fan 320. The action of the vacuum emptying system fan 320 may also pull airflow 906 in from the vacuum compartment intake port 140, across the dirt collector 146, over the dirt release latch 148, into the vacuum emptying system intake port 316, through the vacuum emptying system filter bag 318, and out the vacuum emptying system exhaust port 324. In combination, airflow 904 and airflow 906 may pull dirt and dust from the dirt collector 146 into the vacuum emptying system filter bag 318, emptying the dirt collector 146 for future vacuuming tasks. The vacuum emptying system filter bag 318 may be manually discarded and replaced on a regular basis.

FIG. 10 depicts an embodiment of a robotic control system 1000 to implement components and process steps of the systems described herein. Some or all portions of the robotic control system 1000 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 1000 on a cloud server and/or user's mobile computing device may control more than one robot at a time, allowing multiple robots to work in concert within a working space.

Input devices 1004 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 1004 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1004 are provided via various machine signal conductors (e.g., busses or network interfaces) and circuits to memory 1006.

The memory 1006 is typically what is known as a first- or second-level memory device, providing for storage (via configuration of matter or states of matter) of signals received from the input devices 1004, instructions and information for controlling operation of the central processing unit or processor 1002, and signals from storage devices 1010. The memory 1006 and/or the storage devices 1010 may store computer-executable instructions and thus forming logic 1014 that when applied to and executed by the processor 1002 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 1014 may include portions of a computer program, along with configuration data, that are run by the processor 1002 or another processor. Logic 1014 may include one or more machine learning models 1016 used to perform the disclosed actions. In one embodiment, portions of the logic 1014 may also reside on a mobile or desktop computing device accessible by a user to facilitate direct user control of the robot.

Information stored in the memory 1006 is typically directly accessible to the processor 1002 of the device. Signals input to the device cause the reconfiguration of the internal material/energy state of the memory 1006, creating in essence a new machine configuration, influencing the behavior of the robotic control system 1000 by configuring the processor 1002 with control signals (instructions) and data provided in conjunction with the control signals.

Second- or third-level storage devices 1010 may provide a slower but higher capacity machine memory capability. Examples of storage devices 1010 are hard disks, optical disks, large-capacity flash memories or other non-volatile memory technologies, and magnetic memories.

In one embodiment, memory 1006 may include virtual storage accessible through a connection with a cloud server using the network interface 1012, as described below. In such embodiments, some or all of the logic 1014 may be stored and processed remotely.

The processor 1002 may cause the configuration of the memory 1006 to be altered by signals in storage devices 1010. In other words, the processor 1002 may cause data and instructions to be read from storage devices 1010 in the memory 1006 which may then influence the operations of processor 1002 as instructions and data signals, and which may also be provided to the output devices 1008. The processor 1002 may alter the content of the memory 1006 by signaling to a machine interface of memory 1006 to alter the internal configuration and then converted signals to the storage devices 1010 alter its material internal configuration. In other words, data and instructions may be backed up from memory 1006, which is often volatile, to storage devices 1010, which are often non-volatile.

Output devices 1008 are transducers that convert signals received from the memory 1006 into physical phenomena such as vibrations in the air, patterns of light on a machine display, vibrations (i.e., haptic devices), or patterns of ink or other materials (i.e., printers and 3-D printers).

The network interface 1012 receives signals from the memory 1006 and converts them into electrical, optical, or wireless signals to other machines, typically via a machine network. The network interface 1012 also receives signals from the machine network and converts them into electrical, optical, or wireless signals to the memory 1006. The network interface 1012 may allow a robot to communicate with a cloud server 1022 containing logic 1014, a mobile device, other robots, and other network-enabled devices.

In one embodiment, a global database 1018 may provide data storage available across the devices that comprise or are supported by the robotic control system 1000. The global database 1018 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 1018 may be a single data structure or may be distributed across more than one data structure and storage platform, as may best suit an implementation of the disclosed solution. In one embodiment, the global database 1018 is coupled to other components of the robotic control system 1000 through a wired or wireless network, and in communication with the network interface 1012.

In one embodiment, a robot instruction database 1020 may provide data storage available across the devices that comprise or are supported by the robotic control system 1000. The robot instruction database 1020 may include the programmatic routines that direct specific actuators of the tidying robot, such as are described previously, to actuate and cease actuation in sequences that allow the tidying robot to perform individual and aggregate motions to complete tasks.

FIG. 11A-FIG. 11D depict some embodiments of sorting a pile of clothing according to some embodiments. The method 1100 includes at step 1100a, approaching a pile of clothing on a sorting surface with the robot. In another embodiment, the robot dumps the clothing onto the sorting surface by tilting forward a scoop holding the clothing. In step 1100b, in some embodiments the robot using a fabric gripper 1104 to grip an item of clothing 1102 in the pile and remove the item of clothing 1102 from the pile in step 1100c. The fabric gripper 1104 may then locate the item of clothing 1102 near the scoop of the robot in step 1100d.

In some embodiments, cameras may be used to identify key points on the item of clothing such as sleeves on a shirt and grab those with the fabric grippers. Step 1100e shows the use the fabric grippers to unbunch/unfold the item of clothing by pulling key points outwards. In some embodiments, the pusher arms may also be extended slightly as seen in step 1100f, moving the item of clothing away from robot on the countertop to help it unbunch/unfold.

In some embodiments, cameras may again be used to identify new key points on the item of clothing such as the bottom of a shirt and grab these with the fabric grippers as seen in step 1100g. The fabric grippers are used to unbunch/unfold the item of clothing by pulling the new key points outwards. As seen in step 1100h, the pusher arms may also be retracted slightly, moving item of clothing towards the robot on the countertop to help it unbunch/unfold.

### Moving Clothing Items from the Scoop on to a Flat Surface

The robot's perception, mapping and localization algorithms are running in the background typically at around 10+FPS. As a result, the environment is mapped, the robot is localized and objects of interest are positioned on the map with a panoptic segmentation model, sensor fusion algorithms (E.g. fusing LIDAR), and other perception algorithms.

When the robot is carrying items of clothing that it wants to sort and fold it may use the following routine. During initial setup the owner may choose a designated folding surface, and may optionally choose to have the robot pre-wipe the surface clean before sorting and folding. There may also be a setting on how different types of obstructions to that surface should be handled. E.g. How should the robot handle a freshly baked pie on the counter that it wanted to use for folding?
1. Navigate to the designated folding surface. If the user has not selected a designated folding surface the robot may auto-select an appropriate surface to use as a default.
2. Determine whether the designated folding surface is free of obstructions. If there are obstructions then the robot may follow a routine to clear the obstructions based on the user's instructions.
3. Determine whether the designated folding surface is known to be clean. If not, the robot may use the accessory gripper to take a cleaning pad and wipe the surface clean.
4. Determine the optimal positioning of the scoop relative to the designated folding surface in order to effectively place items on that surface, and leave room for folding.
5. Execute the robot pre-positioning strategy:
   1. Positioning robot staged near designated folding surface
   2. Positioning scoop adjacent to (or on) designated folding surface
6. Manipulation points are generated for items in the scoop and on the designated folding surface for the transfer of items from the scoop to the folding surface.
7. A movement strategy executes in order to dump, push grip, and move the items (E.g. clothing items) from the scoop to the designated folding surface. This may be a machine learning based strategy (E.g. with reinforcement learning or imitation learning), or it may be a rule/heuristic based strategy. Collision detection & safety algorithms are running in the background to make sure strategies do not result in collisions.
8. Steps 6 and 7 may repeat until the target objects are fully moved onto the designated folding surface. For example, if an object is stuck in the scoop it may be grasped and/or pushed out to further move it.
   1. Strategies may simply involve dumping the scoop at a steep angle in order to drop items onto the surface, but we may also use strategies that combine tilting the scoop slightly, grasping with one arm and pushing with another to more gradually & carefully move items out of the scoop.

### Separating Clothing Items From Pile On Folding Surface

In some embodiments, the robot's perception, mapping and localization algorithms are running in the background typically at around 10+frames-per-second (FPS). As a result, the environment is mapped, the robot is localized and objects of interest are positioned on the map with a panoptic segmentation model, sensor fusion algorithms (E.g. fusing LIDAR), and other perception algorithms.

When the robot is at a designated folding surface with clothing in a pile, and it is wanting to separate an item of clothing from the pile, and unbunch it. In an embodiment, the following procedure may be used:
1. Ensure the scoop is empty, and if not follow a strategy to empty the scoop based on what's being carried.
2. Ensure the scoop is clean, and if not follow a cleaning strategy either using a sanitization station, or having the pusher arm grippers use cleaning pad(s) to wipe the scoop and arms clean. Dispose of cleaning pad(s) afterwards.
3. Determine an optimal folding location using the designated folding surface so that there's empty space to fold in front of the robot/scoop, but where the robot is close enough to grasp nearby unfolded clothing items.
4. Determine the scoop size & configuration needed to execute the folding strategy. E.g. the scoop may need to expand with the side walls folded under.
5. Execute the robot pre-positioning strategy:
   Adjusting scoop size to accommodate folding strategy
   Positioning robot staged near folding area
   Positioning scoop adjacent to folding area
1. Determine a target clothing item for folding that is unconstrained and free to pick up
2. Manipulation points are generated for the target clothing item such as grip points, pusher pad alignment points, and destination points in a target folding zone.
3. A movement strategy executes in order to grip, push and move the target clothing item to the target folding zone. This may be a machine learning based strategy (E.g. with reinforcement learning or imitation learning), or it may be a rule/heuristic based strategy. Collision detection & safety algorithms are running in the background to make sure strategies do not result in collisions.
4. Steps 7 and 8 may repeat until the object is fully moved. For example, if the object is only partially moved to the target folding zone then it may be re-grasped, or re-pushed to further move it.
   Strategies may often involve push grasping & lifting with one arm to minimize the robot's movement, or the robot may have to drive and reposition itself so that it can use both arms and the scoop to move a larger object to the designated folding area. If the robot needs to reposition itself then it should move back to the designated folding area afterwards

### Unbunching Clothing items on Folding Surface

In some embodiments, the robot's perception, mapping and localization algorithms are running in the background typically at around 10+FPS. As a result, the environment is mapped, the robot is localized and objects of interest are positioned on the map with a panoptic segmentation model, sensor fusion algorithms (E.g. fusing LIDAR), and other perception algorithms.

When the robot is at a designated folding surface with a single clothing item that is bunched up, inside out, and not ready for folding we need to follow an unbunching strategy in order to unbunch and invert the clothing item so that it can be folded.

Before beginning it is assumed that steps have already been carried out to make sure the designated folding area is clean & free of obstructions, the robot is positioned adjacent to the folding area, the scoop is empty & correctly configured, the scoop is clean, and that the target clothing item is placed in front of the robot.
1. A machine learning model generates a structured, abstract representation of the clothing item that encodes key physical and semantic elements such as fabric connectivity, large openings (such as sleeves and neck holes), fasteners (including buttons and zippers), and fabric edges. This representation captures both the topology and deformable structure of the garment, enabling reasoning about its current configuration and the affordances for manipulation. Using this representation, the system estimates the following:
   The current configuration of the garment, including deformations such as bunching or inside-out states
   An ideal target configuration, such as a fully unfolded or neatly arranged layout
   A next-step intermediate configuration that serves as a short-term goal
   A sequence of parameterized manipulation actions that incrementally transform the garment from its current state toward the target configuration

The structured representation acts as a shared latent space that supports perception, high-level planning, and execution. It allows the robot to generalize across a variety of clothing types and to plan manipulation strategies that are robust to occlusions, entanglement, and variability in garment structure.
For example with a pair of inside out jeans
   Next target configuration: Full inversion of right leg back to normal
      Action 1: Rotate jeans so that waist edge faces the robot
      Action 2: Left pusher arm gripper grasps waist and lifts to make opening
      Action 3: Extend right pusher arm gripper into leg hole opening
      Action 4: Fully extend right pusher arm gripper to end of leg hole
      Action 5: Grip fabric at end of leg hole and retract right pusher arm gripper
      Action 6: Release both left and right pusher arm pinch grippers
2. Manipulation points are generated for the target clothing item such as grip points, hold points, pusher pad alignment points, and destination movement points.
   Note that these points may be generated both as part of the robot's main perception for manipulation, but also generated on the structural representation so that some points may be out of view.
3. A movement strategy executes in order to grip, push, hold and manipulate the target clothing item incrementally unfold it. This may be a machine learning based strategy (e.g., with reinforcement learning or imitation learning), or it may be a rule/heuristic based strategy. Collision detection & safety algorithms are running in the background to make sure strategies do not result in collisions.
4. Steps 2 and 3 may repeat until the object reaches the next step target configuration or is fully unfolded. For example, if the clothing item has only partially made progress towards the next step target configuration, then it may be re-grasped, and manipulated to further adjust/unfold it.
   In situations where the robot is not able to achieve the next step target configuration then one may go back to step 1 to generate an updated structural representation and new manipulation actions.
   Note: A single model may have multiple heads and so structural representation, next step target configuration, sequential manipulation actions, manipulation points, and action movement strategies may be output from the same model, but it is helpful to break these down into concrete sub-steps.

FIG. 12A-FIG. 12C depict a method 1200 for flattening clothing according to some embodiments. As seen in step 1200a, the fabric grippers of a robot may strategically grab corners of the clothing on a surface using fabric grippers and lift it in the air to let gravity help flatten it. In some embodiments, the robot may intentionally swing the item of clothing, as seen in step 1200b, in a sharp/abrupt motion to encourage flattening. In some embodiments, while the clothing is swinging out and flat as seen in step 1200c, the robot can then lower it onto the surface in step 1200d, and move the pusher arms backwards to lay the item of clothing flat on the countertop as shown in step 1200e. As seen in step 1200f, an overhead top view shows the item of clothing flat on the countertop.

FIG. 13A-FIG. 13G depict a method 1300 for folding clothing according to some embodiments. After an article of clothing has been flattened, it may be necessary to rotate the article of clothing into a different position for folding. As seen in step 1300a, the fabric grippers may grab two strategic points on the item of clothing to enable a 90 degree rotation shown in step 1300b that aligns the side of the clothing with the scoop edge for folding. Next, in step 1300c, the scoop may be positioned on top of item of clothing with edge of the scoop positioned for folding. The pusher arms may be placed in an inverted position so that the fabric grippers can retract fully towards the back of the scoop. The fabric grippers may strategically grip the outer edge of the item of clothing in order to enable a folding motion when retracting the pusher arms. In step 1300d, the pusher arms are retracted straight backwards to complete the fold. The fabric grippers may be released, the pusher arms may be lifted, and the scoop may be moved backwards, leaving the item on the countertop.

In some embodiments, as shown in step 1300e, it may be necessary to rotate the article of clothing for the next fold. To accomplished this two subsequent 90 degree rotations may be necessary to align the opposite side of the clothing with the scoop edge. In step 1300f to step 1300h, the fabric grippers may grip the shirt, extend or contract the gripper arms, rotate the shirt, then grip new points on the shirt until the rotations have been completed. Next, as seen in step 1300i, the scoop may be positioned on top of the item of clothing with edge of the scoop positioned for folding. The pusher arms may be placed in an inverted position so that the fabric grippers can retract fully towards the back of the scoop. The outer edge of the item of clothing is also strategically gripped in order to enable a folding motion when retracting the pusher arms. In step 1300j, the pusher arms are retracted straight backwards to complete the fold. Next the fabric grippers may be released, the pusher arms lifted, and the scoop moved backwards, leaving the item on the countertop.

In some embodiments, it may be necessary to rotate the item of clothing 90 degrees to align the perpendicular side of the clothing with the scoop edge. As seen in step 1300k, the fabric grippers may grab strategic points of the clothing and rotate the clothing 90 degrees by retracting the pusher arms as seen in step 1300l. In some embodiments, it may be necessary to fold the clothing again. As seen in step 1300m, the scoop may be positioned on top of the item of clothing with edge of the scoop positioned for folding. The pusher arms may be placed in an inverted position so that the fabric grippers can retract fully towards the back of the scoop. The outer edge of the item of clothing is also strategically gripped in order to enable a folding motion when retracting the pusher arms. In step 1300n, the pusher arms are retracted straight backwards to complete the fold. Next the fabric grippers may be released, the pusher arms lifted, and the scoop moved backwards, leaving the item on the countertop.

### Folding Clothing Items on Folding Surface

The robot's perception, mapping and localization algorithms are running in the background typically at around 10+FPS. As a result, the environment is mapped, the robot is localized and objects of interest are positioned on the map with a panoptic segmentation model, sensor fusion algorithms (E.g. fusing LIDAR), and other perception algorithms.

When the robot is at a designated folding surface with a single clothing item that is unbunched and ready for folding we need to follow a folding strategy in order to fold the clothing item so that it can be put away nicely.

Before beginning we will assume that steps have already been carried out to make sure the designated folding area is clean & free of obstructions, the robot is positioned adjacent to the folding area, the scoop is empty & correctly configured, the scoop is clean, that the target clothing item is placed in front of the robot, and that the target clothing item has been unbunched and flattened.

1. A machine learning model generates a structured, abstract representation of the clothing item that includes structural elements like fabric connection, large holes, buttons, zippers and fabric edges. It also generates an estimated current configuration, ideal folded configuration, a next step target configuration, and a series of sequential manipulation actions to achieve that next step.
1. For example with a shirt
2. Next target configuration: Fold right edge of shirt
   1. Action 1: Rotate shirt so that left side faces robot
   2. Action 2: Place scoop on top of shirt aligned for a clean fold crease
   3. Action 3: Grasp shirt arm at strategic grasping points using pusher arm grippers
   4. Action 4: Retract pusher arm grippers to fold shirt edge inwards
   5. Action 5: Release both left and right pusher arm grippers
      2. Manipulation points are generated for the target clothing item such as grip points, hold points, pusher pad alignment points, and destination movement points.
1. Note that these points may be generated both as part of the robot's main perception for manipulation, but also generated on the structural representation so that some points may be out of view.
   3. A movement strategy executes in order to grip, push, hold and manipulate the target clothing item incrementally fold it. This may be a machine learning based strategy (E.g. with reinforcement learning or imitation learning), or it may be a rule/heuristic based strategy. Collision detection & safety algorithms are running in the background to make sure strategies do not result in collisions.
   4. Steps 2 and 3 may repeat until the object is fully folded. For example, if a fold step is only partially completed then the clothing item may be re-grasped, and manipulated to further fold it.
1. If the object becomes bunched during folding then we may have to run an unbunching strategy, and then re-run our folding strategy from the start.
Note: A single model may have multiple heads and so structural representation, next step target configuration, sequential manipulation actions, manipulation points, and action movement strategies may be output from the same model, but it's helpful to break these down into concrete sub-steps.

FIG. 14A-FIG. 14C depict a method 1400 of rotating an item of clothing for pickup in an embodiment. In step 1400a, the item is grasped with the fabric grippers and rotated 90 degrees by retracting the gripper arms in step 1400b. In step 1400c, the item grasped with the fabric grippers again, and is is rotated another 90 degrees by retracting the gripper arms in step 1400d. In an embodiment, the purpose of rotating the object is so that a folded edge of the clothing item may be pulled into the scoop, which is les likely to catch on the scoop edge than an unfolded edge of clothing. In step 1400e, the fabric grippers may be used to grab the folded side of the item of clothing. Next, the pusher arms are retracted to bring the item of clothing into the scoop as seen in step 1400f.

### Moving Clothing Item into Scoop

The robot's perception, mapping and localization algorithms are running in the background typically at around 10+FPS. As a result, the environment is mapped, the robot is localized and objects of interest are positioned on the map with a panoptic segmentation model, sensor fusion algorithms (E.g. fusing LIDAR), and other perception algorithms.

When the robot is at a designated folding surface with a single folded clothing item that is folded that is ready to be stacked or put away then we need to follow a careful pickup strategy that doesn't result in the clothing becoming bunched.

Before beginning we will assume that steps have already been carried out to make sure the designated folding area is clean & free of obstructions, the robot is positioned adjacent to the folding area, the scoop is empty, the scoop is clean, that the target clothing item is placed in front of the robot, and that the target clothing item has been folded.

1. Determine the destination location where folded clothing items should be placed. E.g. stacked in a pile nearby
2. Determine the scoop size & configuration needed to execute the pickup strategy. E.g. scoop may need to shrink with the side walls folded under if the destination is narrow.
3. Execute the robot pre-positioning strategy:
1. Adjusting scoop size to accommodate folding strategy
2. Positioning robot staged near folding area
3. Positioning scoop adjacent to folding area
   4. A machine learning model generates a structured, abstract representation of the clothing item that includes structural elements like fabric connection, large holes, buttons, zippers and fabric edges. It also generates an estimated current configuration, current location on designated folding area, target location on scoop, and a series of sequential manipulation actions to move the clothing item onto the scoop.
1. For example with a shirt
2. Next target configuration: Fold right edge of shirt
   1. Action 1: Rotate shirt so that folded edge faces scoop edge
   2. Action 2: Left/right pusher arm grippers grasp left/right of folded edge
   3. Action 3: Retract pusher arm grippers to pull shirt onto the scoop
   4. Action 5: Release both left and right pusher arm grippers
      5. Manipulation points are generated for the target clothing item such as grip points, hold points, pusher pad alignment points, and destination movement points.
1. Note that these points may be generated both as part of the robot's main perception for manipulation, but also generated on the structural representation so that some points may be out of view.
   6. A movement strategy executes in order to grip, push, hold and manipulate the target clothing item moving it into the scoop. This may be a machine learning based strategy (E.g. with reinforcement learning or imitation learning), or it may be a rule/heuristic based strategy. Collision detection & safety algorithms are running in the background to make sure strategies do not result in collisions.
   7. Steps 5 and 6 may repeat until the object is fully moved into the scoop. For example, if the clothing item isn't centered in the scoop, then its location may be adjusted slightly.

FIG. 15A-FIG. 15C depict a method 1500 of folding clothes according to some embodiments. An alternative approach to having a tidying robot fold clothing is for it to fold clothing over the scoop edge, mid-air, instead of performing the folding on a flat surface. In step 1500a, the robot grasps an article of clothing with fabric grippers and lifts it from a surface. The scoop is in a tilted back position and is not touching the article of clothing. In step 1500b, the scoop is rotated slightly forward until it slightly contacts the article of clothing near the center of the garment. In some embodiments, the location where the garment is contacted is about halfway down the garment from the fabric grippers. In step 1500c, the fabric grippers release the article of clothing and the top portion of the clothing falls onto the top surface of the bottom of the scoop. In some embodiments as shown in step 1500d, the robot approaches a surface and the scoop is lowered below the top of a surface until the bottom portion of the article of clothing is just under the top edge of the surface. In step 1500e, the scoop is tilted forward as the scoop is raised to the height of the surface. In step 1500f, the folded item of clothing is shown resting on the surface with the scoop resting between the top and bottom of the folded item of clothing. In some embodiments as seen in step 1500g, the scoop is removed from the folded item of clothing by backing up the robot or by retracting the scoop. In some embodiments, the fabric grippers and/or the pusher pads may slightly press on the rear portion of the folded item of clothing as the scoop is withdrawn, to keep the item from sliding off the surface.

FIG. 16A-FIG. 16B illustrate a method 1600 for placing folded clothing on a shelf in some embodiments. In step 1600a, the robot is navigated to a shelf, with the folded item of clothing resting in the bottom of the scoop. The robot scoop is also at approximately the same height as the desired shelf. In step 1600b, the scoop of the robot is slightly raised above the surface and the robot drives forward so that the front edge of the scoop is approximately where the back edge of the folded item will rest on the shelf. The scoop is tilted slightly forward and the folded item begins to slide onto the surface. The scoop is withdrawn from the back of the shelf, allowing the item to continue sliding onto the surface. In some embodiments, the fabric grippers and or pusher pads may be used to help move the item onto the shelf. In step 1600c, the folded item rests completely on the shelf, and the scoop is removed completely removed from the shelf.

### Moving Clothing Item from Scoop and Stacking it

The robot's perception, mapping and localization algorithms are running in the background typically at around 10+FPS. As a result, the environment is mapped, the robot is localized and objects of interest are positioned on the map with a panoptic segmentation model, sensor fusion algorithms (E.g. fusing LIDAR), and other perception algorithms.

When the robot is carrying a single folded clothing item that is folded that is ready to be stacked or put away then we need to follow a careful drop off strategy that doesn't result in the clothing becoming bunched.

Before beginning one assumes that the robot is positioned near the destination area, that the robot is carrying the folded clothing item and that there's no obstructions.

1. Determine the destination location where folded clothing items should be placed. (e.g., stacked in a pile on table)
2. Execute the robot pre-positioning strategy:
Positioning robot staged near drop off stacking area
Positioning scoop adjacent to drop off stacking area
   1. A machine learning model generates a structured, abstract representation of the clothing item that includes structural elements like fabric connection, large holes, buttons, zippers and fabric edges. It also generates an estimated current configuration, current location on designated folding area, target location on scoop, and a series of sequential manipulation actions to move the clothing item onto the scoop.
1. For example with a shirt
2. Next target configuration: Drop shirt on top of stack
   1. Action 1: Align scoop edge with back edge of stacked shirts
   2. Action 2: Left/right pusher arm grippers grasp left/right of folded shirt edge
   3. Action 3: Tilt scoop forward so that front shirt edge feels some gravity
   4. Action 4: Extend left/right pusher arms so that edge of shirt touches pile
   5. Action 5: Slowly move scoop back across pile while extending pusher arms to lay shirt flat
   6. Action 6: Release both left and right pusher arm grippers
      2. Manipulation points are generated for the target clothing item such as grip points, hold points, pusher pad alignment points, and destination movement points.
1. Note that these points may be generated both as part of the robot's main perception for manipulation, but also generated on the structural representation so that some points may be out of view.
   3. A movement strategy executes in order to grip, push, hold and manipulate the target clothing item moving it onto the pile. This may be a machine learning based strategy (e.g., with reinforcement learning or imitation learning), or it may be a rule/heuristic based strategy. Collision detection & safety algorithms are running in the background to make sure strategies do not result in collisions.
   4. Steps 4 and 5 may repeat until the object is fully moved onto the pile. For example, if the clothing item isn't centered on the pile, then it may be pulled back into the scoop and we may try again.

FIG. 17A-FIG. 17C illustrate a method 1700 for folding pants in some embodiments. In step 1700a, a pair of pants is flat on a surface, near the edge of the surface with the pant legs parallel to the edge of the surface. The scoop is applied on top of the pant leg closest to the edge of the surface, such that the front edge of the scoop bisects the pants between the front and back legs. The pusher arms are placed in an inverted and extended position such that the fabric grippers can be retracted towards the back of the scoop. Additionally, the fabric grippers are also applied to the waistband and cuff of the pant leg furthest from the edge of the surface. In step 1700b, the pusher arms are retracted backwards to complete the first fold. Then the fabric grippers are released, the pusher arms lifted, and the scoop is lifted and moved backwards leaving the first folded item 1702 on the countertop. Next the first folded item 1702 is rotated and oriented such that the item is perpendicular to the front edge of the surface with the cuffs 1704 placed furthest from the front edge of the surface. In step 1700c, the scoop is applied on top of the first folded item 1702, such that the front edge of the scoop bisects the pants between the waistband and the cuffs of the legs. The pusher arms are placed in an inverted and extended position such that the fabric grippers can be retracted towards the back of the scoop. Additionally, the fabric grippers are also applied to the cuffs 1704 of the pant legs of the first folded item 1702. In step 1700d, the pusher arms are retracted backwards to complete the second fold. Then the fabric grippers are released, the pusher arms lifted, and the scoop is lifted and moved backwards leaving the second folded item 1706 on the surface as seen in step 1700e.

FIG. 18A-FIG. 18B illustrate method 1800 for folding socks according to some embodiments. Two socks may be positioned together on a surface, one on top of the other. Next, as shown in step 1800a, the scoop is applied on top of the socks, such that the front edge of the scoop bisects the socks at the heel, between the toes and the top elastic band. The pusher arms are placed in an inverted and extended position such that the fabric grippers can be retracted towards the back of the scoop. Additionally, the fabric grippers are also applied to the elastic band of the socks. In step 1800b, the pusher arms are retracted backwards to complete the fold. Then the fabric grippers are released, the pusher arms lifted, and the scoop is lifted and moved backwards leaving the folded pair of socks on the surface as seen in step 1800c.

FIG. 19A-FIG. 19B illustrate a method 1900 for folding a long-sleeved shirt in some embodiments. Folding a long-sleeve shirt is similar to folding a short sleeve shirt. The fabric gripper should focus more on grabbing the outer edge of the sleeve and folding inwards over the scoop edge as shown in step 1900a. In some embodiments, if the bottom of the shirt doesn't follow the sleeve, then the right fabric gripper 1904 may complete folding the sleeve over as seen in step 1900b, and then grab and separately fold the bottom of the shirt over the scoop edge.

When manipulating objects with the general purpose tidying robot such as having it fold clothing or opening appliance doors, the robot may often use a deep learning model to generate key points for specifically manipulating certain objects, often alongside panoptic segmentation, which labels both whole objects and their individual parts. In some embodiments, these tasks are commonly handled by a single model with a shared backbone and multiple output heads, such as one for segmentation and another for key point detection, enabling efficient joint inference.

In particular, these manipulation key points may often differ from visual key points in that for example the correct fold points on clothing may often simply be along an edge a certain distance from a corner where the corner is visually distinctive, but the fold point is not visually unique.

The following is a discussion of aspects of the key point identification system:

### Core Perception Modules

Segmentation: identify objects and their parts (e.g., shirt vs. sleeve).
Landmarks: detect distinctive points (e.g., corners, handles, rims).
Affordance heatmaps: highlight where actions are possible (grip, hold, push, align).
Keypoint solver: select specific contact points, respecting constraints (offset from corner, symmetry, opposing sides).
   Task Configuration (Recipes) Each task is defined as a recipe made of steps. A step specifies:
Action type (grip, hold, lift, align).
Target object/part (shirt hem, pant leg, pot lid).
Constraints (e.g., “on edge,” “10 cm from corner,” “symmetric pair”).
End-effector type (gripper, scoop, pad).
Next step (what follows once this action is done).

This separates what to do (recipe) from how to see and act (perception+solver).

### Control & Planning

Step planner: reads the current step from the recipe.
Motion planner: turns chosen key points into robot motions.
State updater: records progress (which folds done, whether lid removed, etc.).
   Learning Loops (Continuous Improvement) The robot improves over time using three complementary approaches:
1. Imitation Learning (IL)
   Learn initial behaviors from human demonstrations.
   Fast way to bootstrap skills.
1. Self-Supervised Learning
   Robot interacts with objects and learns from the outcomes (e.g., pulling on cloth to see how it moves).
   Improves perception and generalization without human labels.
1. Reinforcement & Human Corrections
   Rewards from task success (e.g., neat fold, stable pot lift).
   Human corrections can guide the robot without giving full new demos.
   Refines skills beyond what was demonstrated.

### Runtime Workflow

1. Perception: segmentation, landmarks, affordances.
2. Step selection: read the next step from the recipe.
3. Keypoint solver: pick exact manipulation points under step constraints.
4. Motion execution: plan and perform the action.
5. Feedback: log success/failure; use for imitation, self-supervised, or RL updates.
6. Advance to next step until task is complete.

### SUMMARY

Configurable: new tasks only require a new recipe file.
Reusable perception: segmentation, landmarks, affordances work across tasks.
Improves over time: imitation to start, self-supervision for generalization, reinforcement/corrections for refinement.
Step-wise execution: robot only focuses on the next action, reducing complexity.

### Example Configuration

task: fold_pants steps: -step: fold_leg_over action: grip target: pant_leg constraints: {fold_over: other_leg} end_effector: gripper next: fold_ankles_up -step: fold_ankles_up action: grip target: pant_ankles constraints: {fold_towards: waist} end_effector: gripper next: optional_stack -step: optional_stack action: grip target: folded_pants constraints: {fold_towards: half_height} end_effector: gripper next: done
task: fold_shirt steps: -step: fold_left_side action: grip target: shirt_hem constraints: {offset_from_corner: 10 cm, edge_aligned: true} end_effector: gripper next: fold_right_side-step: fold_right_side action: grip target: shirt_hem constraints: {symmetric_to: fold_left_side} end_effector: gripper next: fold_bottom -step: fold_bottom action: grip target: shirt_hem constraints: {fold_towards: collar} end_effector: gripper next: done
task: fold_pants steps: -step: fold_leg_over action: grip target: pant_leg constraints: {fold_over: other_leg}
Moving a Pot to the Scoop:
task: move_pot_to_scoop steps: -step: place_lift_pads action: hold target: pot_rim constraints: {two_points_opposite: true} end_effector: pads next: slide_pot -step: slide_pot action: translate target: scoop_surface constraints: {path: countertop_to_scoop, scoop_aligned: true} end_effector: pads next: release_pot -step: release_pot action: release target: pot constraints: {stable_on: scoop_surface} end_effector: pads next: done

### Segmentation

What: Split the image into objects and their parts, for example shirt body and sleeves, or pot and lid.
Why: Actions target specific parts, so the robot needs clear masks and edges.

### Landmarks

What: Distinctive points on the object such as corners, handles, or rim points.
Why: They provide anchors for actions like “grip 10 cm from this corner” even if the exact grip point is not visually unique.

### Affordance Heatmaps

What: A map showing which regions are suitable for an action like grip, hold, push, or align.
Why: They highlight feasible zones for the current step, helping the robot focus on where the action will succeed.

### Keypoint Solver

What: A module that converts landmarks and affordance maps into precise contact points and orientations.
Why: It enforces constraints such as “on an edge,” “a fixed offset from a landmark,” “symmetric pairs,” or “two opposing contact points,” ensuring the chosen key points are physically valid and task-appropriate.

### How They Work Together

Segmentation isolates the correct part of the object.
Landmarks identify reference anchors.
Affordance maps highlight suitable regions.
The Keypoint solver selects the exact contact points that satisfy the step's constraints.

The backbone (for example a CNN) processes the image once to extract general visual features. Multiple heads branch from it:
Segmentation head: Predicts object and part masks.
Landmark head: Predicts anchor points such as corners or handles.
Affordance head: {redicts heatmaps showing where specific actions are possible.
Keypoint solver is either:
   A separate solver module that applies explicit rules and constraints (for example “choose a point on the hem edge offset from a corner” or “pick two symmetric points”)
   A neural head that directly predicts key points from shared features, possibly combined with a lightweight solver to enforce constraints.

This setup is efficient because the robot only runs one forward pass through the backbone, and all perception tasks share the same features. It also helps the model learn better, since tasks like segmentation, landmarks, and affordances reinforce each other.

In some embodiments as shown in FIG. 20, the use of key point identification 2000 is shown folding a shirt.

The shirt is shown with hold points as triangles (where the scoop is used to firmly hold the fabric against a flat surface), and grip points as circles with an “x” (where the fabric grippers grip the fabric for manipulation) that the tidying robot may use for folding a shirt. There may be multiple folding steps, requiring different hold points and grip points.

The key point identification 2000 comprises a first fold hold point 2002, a first fold grip point 2004, a second fold hold point 2006, a second fold grip point 2008, a third fold hold point 2010, and a third fold grip point 2012. All of the hold points and grip points for all of the required folds are shown at once on the shirt.

FIG. 21 illustrate the use of key point identification 2100 to fold a shirt in some embodiments. Often key points are generated for only the next step in the process. For example, the key points for the shirt being folded with different steps are shown. In step 2100a, first fold hold points 2002 and first fold grip points 2004 are shown on the shirt. After the scoop of a robot is applied to the first fold hold points and the fabric grippers are applied to first fold grip points the shirt, a first fold produces a partially folded shirt as seen in step 2100b. Additionally, second fold hold points 2006 and second fold grip points 2008 are generated for the second fold. In step 2100c, the second fold has already occurred, and the third fold hold points 2010 and the third fold grip points 2012 are shown for the third fold. In step 2100d, the folded shirt is shown after the third fold has been completed.

FIG. 22 illustrates the use of a key point identification 2200 to unbunch a shirt in some embodiments. In this example to unbunch a shirt, first the sleeves are unfolded at the first grip unbunch point 2202 locations and then the bottom of the shirt is pulled straight at the second grip unbunch point 2204 locations. In some embodiments, after these two initial unbunching steps, additional key points may be generated for further unbunching and flattening.

FIG. 23 illustrates the use of a key point identification 2300 to fold a pair of pants in some embodiments. The key point identification 2300 comprises a first fold hold point 2002, a first fold grip point 2004, a second fold hold point 2006, a second fold grip point 2008, a third fold hold point 2010, and a third fold grip point 2012. Step 2300a the pants before a first fold is made, folding across with one leg on top of the other, and shows all of the key points need for the first and second folds. In step 2300b, after the first fold has occurred, the key points for the second fold are shown which are the second fold hold points 2006 and the second fold grip points 2008. For the second fold, the bottom of the pant legs are grabbed and folded in half up towards the waist. In this situation one of the grip points is common with both fold actions. In step 2300c, third fold hold points 2010 and third fold grip points 2012 may be generated to fold the pants a third time so that they're easily stackable on a shelf.

FIG. 24 illustrates the use of a key point identification 2400 to fold a pair of shorts in some embodiments. The key point identification 2400 comprises a first fold hold point 2002, a first fold grip point 2004, a step 2400a, and a step 2400b. Similarly to the discussion above for folding a shirt, in step 2400a, the first fold hold points and first fold grip points are shown before the first fold. In step 2400b, the shorts are shown after the first fold, and the second fold hold points and the second fold grip points to carry out the second fold are present on the first folded shorts.

FIG. 25 illustrates the use of a key point identification 2500 to fold a pair of socks in some embodiments. The first fold hold points 2002 and first fold grip point 2004 are shown before the first fold has occurred.

FIG. 26 illustrates the use of a key point identification 2600 to fold a pair of underwear in some embodiments. The first fold hold points 2002 and first fold grip point 2004 are shown before the first fold has occurred.

FIG. 27 illustrates an example method 2700 for sorting and folding clothing. Although the example method 2700 and example method 2800 depict a particular sequence of operations, the sequence may be altered without departing from the scope of the present disclosure. For example, some of the operations depicted may be performed in parallel or in a different sequence that does not materially affect the function of the method 2700 or method 2800. In other examples, different components of an example device or system that implements the method 2700 or method 2800 may perform functions at substantially the same time or in a specific sequence.

According to some examples, the method includes approaching a pile of clothing including articles of clothing, located on a surface, with a tidying robot at block 2702.

According to some examples, the method includes grabbing, with the pusher pad assembly, a selected article of clothing from the pile of clothing located on the surface at block 2704.

According to some examples, the method includes aligning a front edge of the scoop parallel to the front edge of the surface at block 2706.

According to some examples, the method includes moving the selected article of clothing, with the pusher pad assembly, from the pile of clothing to an area of the surface in front of the front edge of the scoop at block 2708.

According to some examples, the method includes identifying, using the at least one camera, a first set of key points on the selected article of clothing representing first manipulation locations at block 2710.

According to some examples, the method includes grabbing, using at least one pusher pad assembly, the selected article of clothing at the first manipulation locations at block 2712.

According to some examples, the method includes pulling the first manipulation locations in directions that unbunch the selected article of clothing, resulting in an unbunched selected article of clothing at block 2714.

FIG. 28 illustrates an example method 2800 for generating key points and folding an item of clothing using those key points.

According to some examples, the method includes approaching an article of clothing, located on a surface, with a tidying robot at block 2802.

According to some examples, the method includes identifying, using the at least one camera, a first set of key points on the article of clothing representing first manipulation locations, the first manipulation locations including at least one first fold hold point and at least one first fold grip point at block 2804.

According to some examples, the method includes holding the at least one first fold hold points with the scoop while gripping the at least one first fold grip points with the pusher pad assembly at block 2806.

According to some examples, the method includes manipulating the pusher pad assembly to fold the article of clothing at block 2808.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device.

Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A method comprising:
approaching a pile of clothing including articles of clothing, located on a surface, with a tidying robot, wherein the tidying robot includes:
a chassis with at least one of at least one wheel and at least one track for mobility of the tidying robot;
a scoop mounted on the tidying robot;
a pair of pusher pad assemblies, each including a pusher pad and a pinch gripper;
a pair of pusher pad arms, each pusher pad of the pair of pusher pad assemblies mounted on one pusher pad arm, each pusher pad arm attached to the scoop and configured to move the pusher pad into a position to grasp the articles of clothing;
the pinch gripper, on the tip of each pusher pad, configured to grip an article of clothing;
a gripper arm attached to the scoop and configured to grasp items;
at least one camera configured to identify a type of clothing and key points on the type of clothing, wherein the key points facilitate manipulation of the articles of clothing;
grabbing, with the pusher pad assembly, a selected article of clothing from the pile of clothing located on the surface;
aligning a front edge of the scoop parallel to the front edge of the surface; and
moving the selected article of clothing, with the pusher pad assembly, from the pile of clothing to an area of the surface in front of the front edge of the scoop.

2. The method of claim 1, further comprising:
identifying, using the at least one camera, a first set of key points on the selected article of clothing representing first manipulation locations;
grabbing, using at least one pusher pad assembly, the selected article of clothing at the first manipulation locations; and
pulling the first manipulation locations in directions that unbunch the selected article of clothing, resulting in an unbunched selected article of clothing.

3. The method of claim 2, further comprising:
identifying, using the at least one camera, a second set of key points representing second manipulation locations useful for flattening the unbunched selected article of clothing;
grabbing, using at least one pusher pad assembly, the unbunched selected article of clothing at the second manipulation locations; and
pulling the second manipulation locations in directions that flatten the unbunched selected article of clothing, resulting in a flattened selected article of clothing.

4. A method comprising:
approaching an article of clothing, located on a surface, with a tidying robot, wherein the tidying robot includes:
a chassis with at least one of at least one wheel and at least one track for mobility of the tidying robot;
a scoop mounted on the tidying robot;
a first pusher pad assembly and a second pusher pad assembly, each including a pusher pad and a pinch gripper;
a first pusher pad arm and a second pusher pad arm;
each pusher pad of each pusher pad assembly mounted on a pusher pad arm, each pusher pad arm attached to the scoop and configured to move the pusher pad assembly into a position to grasp the article of clothing;
the pinch grippers, one on a tip of each pusher pad, configured to grip the article of clothing;
a gripper arm attached to the scoop and configured to grasp items;
at least one camera configured to identify a type of clothing and key points on the type of clothing, wherein the key points facilitate manipulation of the articles of clothing; and
identifying, using the at least one camera, a first set of key points on the article of clothing representing first manipulation locations, the first manipulation locations including at least one first fold hold point and at least one first fold grip point.

5. The method of claim 4, further comprising:
holding the at least one first fold hold points with the scoop while gripping the at least one first fold grip points with the pusher pad assembly; and
manipulating the pusher pad assembly to fold the article of clothing, thereby creating a first fold article of clothing.

6. The method of claim 5, wherein the article of clothing is a sock,
the at least one first fold hold point located, when the sock is flat, at the heel of the sock and at a front of an ankle joint position of the sock; and
the at least one first fold grip point located, when the sock is flat, at a toe end of the sock.

7. The method of claim 5, wherein the article of clothing is a pair of underwear,
the at least one first fold hold point located, when the underwear is flat, at a bottom of the crotch of the underwear and at a waistband position above the crotch of the underwear; and
the at least one first fold grip point located, when the underwear is flat, at one side of the underwear near the waistband and a top of a leg opening.

8. The method of claim 5, further comprising:
identifying, using the at least one camera, a second set of key points on the first fold article of clothing representing second manipulation locations, the second manipulation locations including at least one second fold hold point and at least one second fold grip point.

9. The method of claim 8, further comprising:
determining if a second folding procedure of the first fold article of clothing requires rotation of the first fold article of clothing for the scoop to hold the at least one second fold hold point or for the pusher pad assembly to grip the at least one second fold grip point;
on condition the first fold article of clothing needs to be rotated:
rotating the first fold article of clothing with at least one of the scoop and the pusher pad assembly to a position needed for the second folding procedure.

10. The method of claim 8, further comprising:
holding the at least one second fold hold point with the scoop while gripping the at least one second fold grip point with the pusher pad assembly;
manipulating the pusher pad assembly to fold the first fold article of clothing, thereby creating a second fold article of clothing.

11. The method of claim 10, wherein the article of clothing is a pair of shorts,
the at least one first fold hold point located, when the shorts are flat, at a bottom of the crotch of the shorts and at a waistband position above the crotch of the shorts;
the at least one first fold grip point located, when the shorts are flat, at one side of the shorts near the waistband and a bottom of a leg opening;
the at least one second fold hold point located, when the shorts that have been folded once are flat, at a crotch level of a left seam and a right seam of once folded shorts; and
the at least one second fold grip point located, when the shorts that have been folded once are flat, at the leg opening level of the left seam and the right seam of the once folded shorts.

12. The method of claim 10, further comprising:
grasping the second fold article of clothing with the pusher pad assemblies;
pulling the second fold article of clothing into the scoop with the pusher pad assemblies;
navigating to a shelf;
resting a front edge of the scoop on the shelf;
tilting the scoop forward;
allowing a portion of the second fold article of clothing to slide onto the shelf; and
removing the scoop from the shelf while allowing the portion of the second fold article of clothing to slide onto the shelf.

13. The method of claim 10, further comprising:
identifying, using the at least one camera, a third set of key points on the second fold article of clothing representing third manipulation locations, the third manipulation locations including at least one third fold hold point and at least one third fold grip point.

14. The method of claim 13, further comprising:
holding the at least one third fold hold point with the scoop while gripping the at least one third fold grip point with the pusher pad assembly;
manipulating the pusher pad assembly to fold the second fold article of clothing, thereby creating a third fold article of clothing.

15. The method of claim 14, wherein the article of clothing is a pair of pants,
the at least one first fold hold point located, when the pants are flat, at a bottom of the crotch of the pants and at a waistband position above the crotch of the pants;
the at least one first fold grip point located, when the pants are flat, at one side of the pants near the waistband and a bottom of a leg opening;
the at least one second fold hold point located, when the pants that have been folded once are flat, at a crotch level of a left seam and a right seam of once folded pants;
the at least one second fold grip point located, when the pants that have been folded once are flat, at the leg opening level of the left seam and the right seam of the once folded pants;
the at least one third fold hold point located, when the pants that have been folded twice are flat, halfway along the long side of the left seam and the right seam of twice folded pants; and
the at least one third fold grip point located, when the pants that have been folded twice are flat, at each side of a bottom edge of the short side of the twice folded pants.

16. The method of claim 14, wherein the article of clothing is a shirt,
the at least one first fold hold point located, when the shirt is flat, at one side of the shirt at a bottom edge of the shirt and at a position between a neck opening and a beginning of a sleeve of the shirt;
the at least one first fold grip point located, when the shirt is flat, at one side of the shirt between the beginning of the sleeve and a cuff of the sleeve and on the cuff of the sleeve;
the at least one second fold hold point located, when the shirt that has been folded once is flat, on an unfolded side of the once folded shirt, at one side of the shirt at a bottom edge of the shirt and at a position between a neck opening and a beginning of a sleeve of the shirt;
the at least one second fold grip point located, on the unfolded side of the once folded shirt, at one side of the shirt between the beginning of the sleeve and a cuff of the sleeve and on the cuff of the sleeve;
the at least one third fold hold point located, when the shirt that has been folded twice is flat, halfway, on each side of the long edges of the twice folded shirt; and
the at least one third fold grip point located, when the shirt that has been folded twice is flat, at each side of a bottom edge of the short side of the twice folded shirt.
